(19) United States
(12) Patent Application Publication
(10) Pub. No.: US 2026/0097591 A1
(43) Pub. Date: Apr. 9, 2026

(54) TEST PATTERN, TEST PATTERN PRINTING METHOD, AND PRINTING DEVICE

(71) Applicant: MIMAKI ENGINEERING CO., LTD., Nagano (JP)

(72) Inventor: Arata Kobayashi, Nagano (JP)

(73) Assignee: MIMAKI ENGINEERING CO., LTD., Nagano (JP)

(21) Appl. No.: 18/730,322

(22) PCT Filed: Feb. 3, 2023
(86) PCT No.: PCT/JP2023/003562

§ 371 Date: Jul. 19, 2024

(30) Foreign Application Priority Data
Feb. 3, 2022 (JP) 2022-015383
Feb. 3, 2022 (JP) 2022-015385

(51) Int. Cl. B41J 2/21; B41J 25/316; G06K 15/02

(52) U.S. Cl. CPC B41J 2/2135; B41J 25/316; G06K 15/027; G06K 2215/0094; G06K 2215/101

(57) ABSTRACT

A tilt of a head is discerned. Regions of a test pattern include a base line formed in a Y direction with inks ejected from nozzle portions of heads, and blocks formed with inks ejected from nozzle portions provided at intervals from first nozzle portions of the heads in the Y direction. The block is formed on an X1 side of the base line in an X direction orthogonal to the Y direction, and the block is formed on an X2 side.

### TECHNICAL FIELD

The present invention relates to a test pattern, a test pattern printing method, and a printing device.

### BACKGROUND ART

Printing devices include an inkjet head that ejects inks. The inkjet head includes a plurality of nozzle rows arranged in a main scanning direction. Each nozzle row includes a plurality of nozzles arranged in a sub scanning direction. The printing devices perform printing on a medium by ejecting inks from nozzles while moving the medium and the inkjet head relatively in the main scanning direction and the sub scanning direction.

### CITATION LIST

### Patent Literature

Patent Literature 1: Japanese Unexamined Patent Publication No. 2021-94827

### SUMMARY OF INVENTION

### Technical Problems

Inkjet heads may be at a tilt due to nozzle replacement work or the like. When printing is performed while the inkjet heads are at a tilt, the quality of a printed material may be affected. In printing devices, the tilt of inkjet heads needs to be discerned.

In addition, in a case where any inkjet head of the plurality of inkjet heads is misaligned, dot positions of the inkjet head and dot positions of the other inkjet heads may be misaligned. The dot positions are positions where inks ejected from nozzles of the inkjet head land on a medium.

When the dot positions of the plurality of inkjet heads do not match, the quality of a printed material may be affected. In printing devices, misalignment in dot positions of inkjet heads needs to be discerned.

### Solutions to Problems

According to the present invention, there is provided (1) a test pattern that is printed on a medium by ejecting inks onto the medium from an inkjet head including a plurality of nozzle portions, the test pattern including: first base lines formed in a first direction with inks ejected from first nozzle portions of the inkjet head; and first blocks and second blocks formed with inks ejected from second nozzle portions of the inkjet head which are provided at intervals from the first nozzle portions in the first direction, in which the first blocks are formed on one side of each of the first base lines in a second direction orthogonal to the first direction, and the second blocks are formed on the other side of each of the first base lines.

(2) In the test pattern, a plurality of the first base lines are formed at intervals in the second direction, a plurality of the first blocks are arranged in the second direction on the one side of each of the plurality of first base lines, a plurality of the second blocks are arranged in the second direction on the other side of each of the plurality of first base lines, a set of the plurality of first blocks and a set of the plurality of second blocks are arranged at positions shifted from each other such that the first and second blocks do not overlap each other in the second direction, and the set of the first blocks forms a first figure, and the set of the second blocks forms a second figure.

(3) In the test pattern, the inkjet head is provided to be pivotable about a tilt shaft extending in a third direction orthogonal to the first direction and the second direction.

(4) In the test pattern, the first figure and the second figure are figures having different designs, and one of the first figure and the second figure is visually recognized as a figure darker than the other depending on a pivoting direction of the tilt shaft.

(5) In the test pattern, each of the first figure and the second figure includes a mark indicating the pivoting direction of the tilt shaft.

(6) In the test pattern, the first nozzle portions and the second nozzle portions each include a plurality of nozzles arranged at regular intervals in the second direction, the nozzles of the first nozzle portions and the nozzles of the second nozzle portions are alternately arranged side by side in the second direction, the first base lines are formed by first nozzles of the first nozzle portions, the first blocks are formed by second nozzles of the second nozzle portions, the second nozzles being adjacent to the first nozzles on one side in the second direction, and the second blocks are formed by third nozzles of the second nozzle portions, the third nozzles being adjacent to the first nozzles on the other side in the second direction.

(7) In the test pattern, the first nozzle portions and the second nozzle portions include a plurality of nozzles arranged at regular intervals in the second direction, the nozzles of the first nozzle portions and the second nozzle portions are arranged at the same positions in the second direction, the first base lines are formed by first nozzles of the first nozzle portions, the first blocks are formed by second nozzles of the second nozzle portions, the second nozzles being adjacent to the first nozzles on one side in the second direction, and the second blocks are formed by third nozzles of the second nozzle portions, the third nozzles being adjacent to the first nozzles on the other side in the second direction.

(8) The test pattern further includes: second base lines formed in the first direction with inks ejected from third nozzle portions of the inkjet head; and third blocks that are formed with inks ejected from fourth nozzle portions of the inkjet head which are provided at intervals from the third nozzle portions in the first direction and are adjacent to the second base lines on one side of the second base lines in the second direction; and fourth blocks that are formed with inks ejected from the fourth nozzle portions, are adjacent to the second base lines on the other side of the second base lines in the second direction, and are arranged at intervals from the third blocks in the first direction, in which a distance between the third nozzle portions and the fourth nozzle portions in the first direction is longer than a distance between the first nozzle portions and the second nozzle portions in the first direction.

According to the present invention, there is provided (9) a test pattern printing method for printing a test pattern on a medium by ejecting inks onto the medium from an inkjet head including a plurality of nozzle portions, the test pattern printing method including: forming first base lines in a first direction by ejecting inks from first nozzle portions of the inkjet head; and forming first blocks and second blocks by ejecting inks from second nozzle portions of the inkjet head which are provided at intervals from the first nozzle portions in the first direction, in which the first blocks are formed on one side of each of the first base lines in a second direction orthogonal to the first direction, and the second blocks are formed on the other side of each of the first base lines.

According to the present invention, there is provided (10) a printing device that prints a test pattern on a medium by ejecting inks onto the medium from an inkjet head including a plurality of nozzle portions, the printing device forming: first base lines in a first direction by ejecting inks onto the medium from first nozzle portions of the inkjet head; and first blocks and second blocks by ejecting inks from second nozzle portions of the inkjet head which are provided at intervals from the first nozzle portions in the first direction, in which the first blocks are formed on one side of each of the first base lines in a second direction orthogonal to the first direction, and the second blocks are formed on the other side of each of the first base lines.

In addition, according to the present invention, there is provided (1) a test pattern that is printed on a medium with inks ejected from a first inkjet head and a second inkjet head, the test pattern including: first lines and second lines printed alternately in a first direction, in which the first lines are formed with inks ejected from a plurality of nozzles of the first inkjet head which are arranged in a second direction orthogonal to the first direction, and the second lines are formed with inks ejected from a plurality of nozzles of the second inkjet head which are arranged in the second direction.

(2) In the test pattern, the first line and the second line have an overlap portion where the lines overlap each other when viewed in the first direction, and

the overlap portion is visually recognized as a filled region in a case where landing positions of the inks ejected from the nozzles of the first inkjet head and landing positions of the inks ejected from the nozzles of the second inkjet head coincide in the first direction within a predetermined range determined in advance.

(3) The test pattern further includes: a first reference line formed with the inks ejected from the nozzles of the first inkjet head; and a second reference line formed with the inks ejected from the nozzles of the second inkjet head, in which in a case where the landing positions of the inks ejected from the nozzles of the first inkjet head and the landing positions of the inks ejected from the nozzles of the second inkjet head coincide in the first direction, the first reference line and the second reference line have a superimposed region.

(4) The test pattern further includes a pattern in which, with a virtual line in the first direction as a reference, first linear portions positioned on one side in the second direction from the virtual line and second linear portions positioned on the other side are alternately arranged in the first direction, in which the first linear portions and the second linear portions are formed by superimposing the inks ejected from the nozzles of the first inkjet head and the inks ejected from the nozzles of the second inkjet head.

(5) In the test pattern, the pattern has, on the one side of the virtual line, a first region filled with the inks ejected from the nozzles of the first inkjet head and, on the other side, a second region filled with the inks ejected from the nozzles of the second inkjet head, and the first linear portions and the second linear portions are formed by facing end portions of the first region and the second region.

(6) In the test pattern, in a case where the landing positions of the inks ejected from the nozzles of the first inkjet head and the landing positions of the inks ejected from the nozzles of the second inkjet head do not coincide in the second direction, a gap or a high-density region is generated at a boundary between the first region and the second region.

(7) In the test pattern, the first linear portions and the second linear portions are parallel to the virtual line, end portions of the first linear portions and the second linear portions are connected to each other by third linear portions orthogonal to the virtual line, and the third linear portions are formed by superimposing the inks ejected from the nozzles of the first inkjet head and the inks ejected from the nozzles of the second inkjet head.

According to the present invention, there is provided (8) a test pattern printing method for printing a test pattern on a medium by ejecting inks from a first inkjet head and a second inkjet head, the test pattern printing method including: printing first lines and second lines alternately in a first direction; forming the first lines by ejecting inks from a plurality of nozzles of the first inkjet head which are arranged in a second direction orthogonal to the first direction; and forming the second lines by ejecting inks from a plurality of nozzles of the second inkjet head which are arranged in the second direction.

According to the present invention, there is provided (9) a test pattern printing method for printing a test pattern on a medium by ejecting inks from a first inkjet head and a second inkjet head, the test pattern printing method including: printing first lines and second lines alternately in a first direction; forming the first lines by ejecting inks from a plurality of nozzles of the first inkjet head which are arranged in a second direction orthogonal to the first direction; and forming the second lines by ejecting inks from a plurality of nozzles of the second inkjet head which are arranged in the second direction.

### Effect of the Invention

According to the present invention, from a test pattern, a tilt of an inkjet head can be discerned.

In addition, according to the present invention, from the test pattern, misalignment in a dot position of the inkjet head can be discerned.

### BRIEF DESCRIPTION OF THE DRAWINGS

FIG. 1 is a perspective view of a printing device from a front side.

FIG. 2 is a block diagram illustrating a configuration of the printing device.

FIG. 3 is a view schematically illustrating a head portion from the front side.

FIG. 4 is a view schematically illustrating the head portion from above.

FIG. 5 is a view schematically illustrating arrangement of nozzles constituting a nozzle part.

FIG. 6 is a view illustrating a printing example in a case where dot positions of heads coincide with each other.

FIG. 7 is a view illustrating a printing example in a case where the dot positions of the heads do not coincide.

FIG. 8 is a flowchart illustrating an example of a procedure of correction.

FIG. 9 is a view illustrating a test pattern for tilt correction.

FIG. 10 is an enlarged view of a portion surrounded by box A in FIG. 9.

FIG. 11 is a view illustrating a method of forming a test pattern.

FIG. 12 is a view for illustrating a change in the test pattern in a case where a head is at a tilt.

FIG. 13 is a view for illustrating a change in the test pattern in a case where the head is at a tilt.

FIG. 14 is a view for illustrating a positional relationship between nozzle portions.

FIG. 15 is a view for illustrating a case where the head is at a large tilt.

FIG. 16 is a view for illustrating a case where the head is at a small tilt.

FIG. 17 is a view illustrating a test pattern for positional misalignment correction in a Y direction.

FIG. 18 is a view for illustrating a method of forming a test pattern.

FIG. 19 is a view for illustrating a change in the test pattern in a case of a positional misalignment of the heads in the Y direction.

FIG. 20 is a view illustrating a test pattern for positional misalignment correction in an X direction.

FIG. 21 is an enlarged view of a portion surrounded by box A in FIG. 20.

FIG. 22 is a view for illustrating a change in the test pattern in a case of a positional misalignment of the heads in the X direction.

FIG. 23 is a view illustrating the test pattern in a case of a positional misalignment of the heads in the Y direction.

FIG. 24 is a view illustrating a method of forming a test pattern according to Modification Example 1.

### DESCRIPTION OF EMBODIMENTS

Hereinafter, embodiments of the present invention will be described.

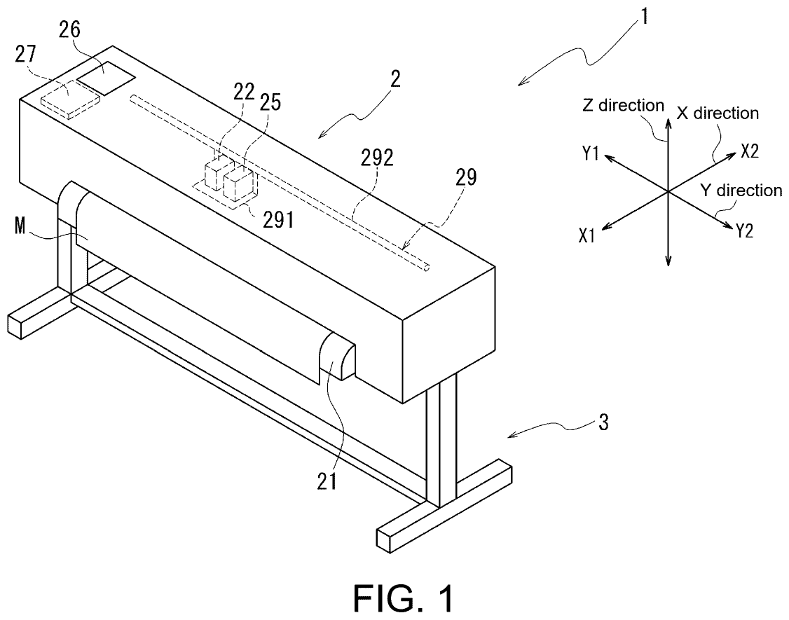

FIG. 1 is a perspective view of a printing device 1 from a front side.

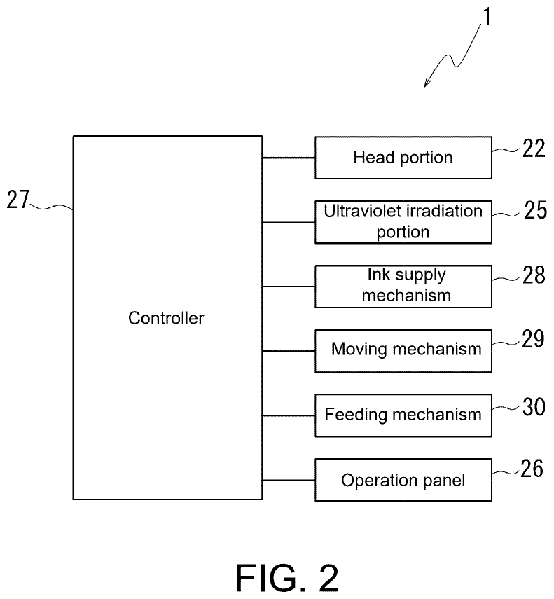

FIG. 2 is a block diagram illustrating a configuration of the printing device 1.

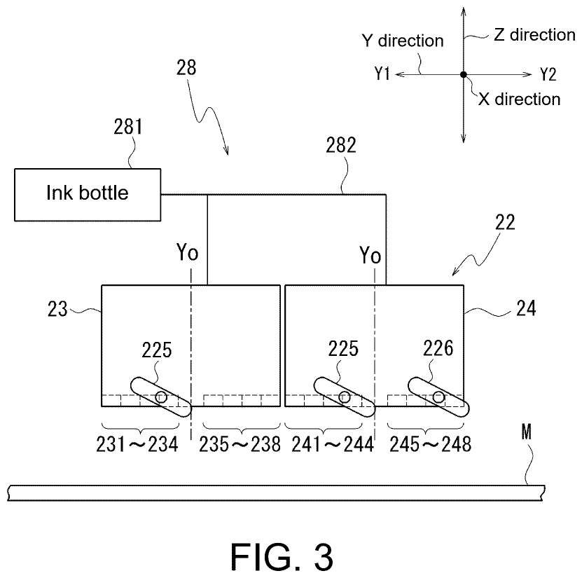

FIG. 3 is a view schematically illustrating a head portion 22 from the front side.

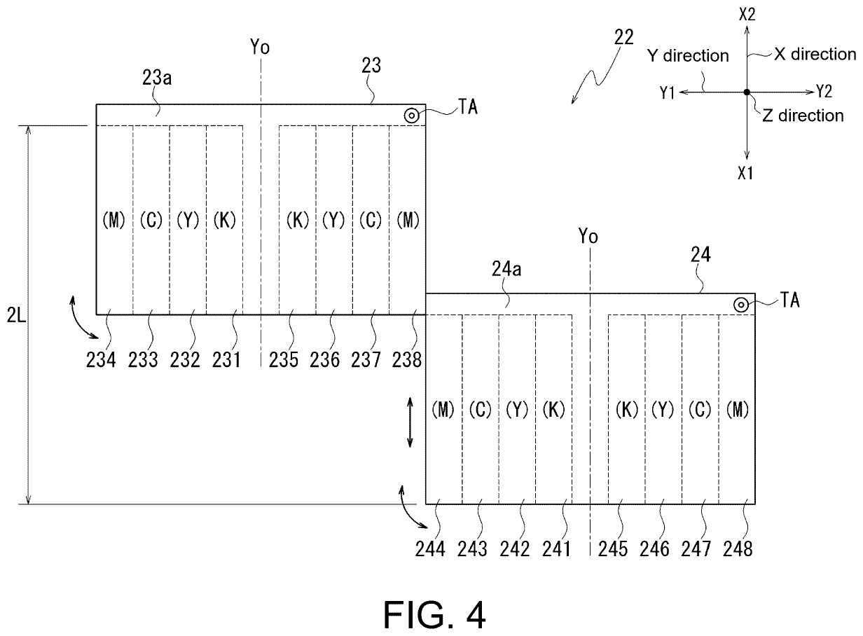

FIG. 4 is a view schematically illustrating the head portion 22 from above.

In the following description, a “Y direction” means a main scanning direction (first direction) of the printing device 1. The main scanning direction is a leftward-rightward direction as viewed from a front surface of the printing device 1. An “X direction” means a sub scanning direction (second direction). The sub scanning direction is a direction orthogonal to the main scanning direction, and is a direction from a front surface side toward a back side of the printing device 1. A “Z direction” means a vertical-line direction in a case where the printing device 1 is placed on a horizontal surface, and is a direction (third direction) orthogonal to the X direction and the Y direction. In addition, a “Y1 side” means one side (left side in FIG. 3) in the Y direction when viewed from a front surface of the printing device 1, and a “Y2 side” means the other side (right side in FIG. 3). An “X1 side” means the front surface side of the printing device 1, and an “X2 side”means the back side.

The printing device 1 performs printing on a medium M by an inkjet method. The medium M may be, for example, paper, fabric, or a resin film.

As illustrated in FIG. 1, the printing device 1 includes a main body 2 and a trestle 3 that supports the main body 2. The main body 2 includes a platen 21 that supports the medium M. Further, the main body 2 includes a head portion 22 that ejects an ultraviolet-curable ink onto the medium M, and an ultraviolet irradiation portion 25 that irradiates the ink ejected on the medium M with an ultraviolet ray. The main body 2 includes an operation panel 26 that receives a user's operation input, and a controller 27 that controls an operation of the printing device 1.

As illustrated in FIG. 2, the printing device 1 includes an ink supply mechanism 28 that supplies an ink to the head portion 22, a moving mechanism 29 that moves the head portion 22 and the ultraviolet irradiation portion 25 in the Y direction, and a feeding mechanism 30 that feeds the medium M in the X direction.

As illustrated in FIG. 3, the ink supply mechanism 28 includes an ink bottle 281 that stores ink, and an ink supply channel 282 that connects the ink bottle 281 and the head portion 22.

As illustrated in FIG. 1, the moving mechanism 29 (see FIG. 2) includes a carriage 291 on which the head portion 22 and the ultraviolet irradiation portion 25 are mounted, and a guide rail 292 that guides the carriage 291. The guide rail 292 is disposed in the Y direction of the main body 2. Although not illustrated, the moving mechanism 29 includes a belt, a driving pulley and a driven pulley around which the belt is wound, and a motor that rotates the driving pulley. The carriage 291 is fixed to a driving belt. The motor rotates the driving belt, and thereby the carriage 291 moves the main body 2 in the Y direction along the guide rail 292.

Although not illustrated, the feeding mechanism 30 (see FIG. 2) includes a motor, a roller rotated by the motor, and a plurality of pinch rollers. The roller is rotated while the medium M is pinched between the roller and the plurality of pinch rollers. In this manner, the medium M is fed in the X direction. The medium M is fed from the X2 side to the X1 side. That is, in a feeding direction of the medium M, the X2 side is the upstream side, and the X1 side is the downstream side.

The printing device 1 moves the carriage 291 in the Y direction by the moving mechanism 29, and feeds the medium M in the X direction by the feeding mechanism 30. Consequently, the carriage 291 moves relative to the medium M in the X direction and the Y direction. The printing device 1 ejects the ultraviolet-curable ink from the head portion 22 onto the medium M while moving the carriage 291. The printing device 1 cures, by the ultraviolet irradiation portion 25, the ink that has landed on the medium M. Consequently, printing on the medium M is performed.

The operation panel 26 can be, for example, a touch panel. The operation panel 26 displays an image output from the controller 27 and receives an operation input from the user. The operation panel 26 may include, for example, a display that displays an image, a switch that receives an operation input, and the like.

The controller 27 controls an operation of each portion of the printing device 1. The controller 27 can be, for example, a microcomputer or the like. The controller 27 includes a processor such as a central processing unit (CPU) and a memory such as a hard disk drive (HDD), a solid state drive (SSD), and a random access memory (RAM). The CPU executes a program stored in the memory, and thereby the operation of the printing device 1 is executed.

The controller 27 includes a communication device, and receives, from an external computer or the like, image data to be printed on the medium M.

The controller 27 generates, from the input image data, print data for controlling each portion of the printing device 1. The print data contains a dot position. The dot position means a landing position of inks ejected from the head portion 22 on the medium M. The dot position is represented by, for example, XY coordinates. The controller 27 converts position coordinates of each pixel contained in an image into a dot position to generate print data.

The controller 27 controls the feeding mechanism 30 and the moving mechanism 29 based on the print data to move the head portion 22 to the dot position and eject the ink.

As illustrated in FIG. 3, the head portion 22 includes two inkjet heads 23 and 24 (hereinafter, simply referred to as “heads 23 and 24”). The heads 23 and 24 are arranged to face the medium M on the platen 21 (see FIG. 1).

As illustrated in FIG. 4, the heads 23 and 24 are arranged in a so-called staggered arrangement. The heads 23 and 24 are arranged at positions shifted in the X direction and the Y direction. The head 24 is disposed on the Y2 side of the head 23 in the Y direction, and is disposed on the X1 side of the head 23 in the X direction. The head 24 is disposed downstream of the head 23 in the feeding direction of the medium M. When viewed in the Y direction, a part of the head 24 overlaps the head 23.

The head 23 includes eight nozzle portions 231 to 238 arranged in the Y direction. Similarly, the head 24 includes eight nozzle portions 241 to 248 arranged in the Y direction. As illustrated in FIG. 4, end regions 23a and 24a in which the nozzle portions 231 to 238 and 241 to 248 are not formed are provided on the X2 side of the heads 23 and 24. The end region 24a of the head 24 overlaps the head 23 when viewed in the Y direction.

As illustrated in FIG. 3, the nozzle portions 231 to 238 and 241 to 248 are provided in surfaces of the heads 23 and 24 facing the medium M, respectively.

The heads 23 and 24 have ink supply ports (not illustrated) connected to the ink supply channel 282. The ink is supplied from the ink bottle 281 to the nozzle portions 231 to 238 and 241 to 248 of the heads 23 and 24, respectively, via the ink supply channel 282 and the ink supply ports.

In the embodiment, as an example, four colors of inks of cyan (C), magenta (M), yellow (Y), and key plate (K) are supplied to the heads 23 and 24. Here, an example in which black is used as the key plate will be described. In FIG. 4, the colors of inks supplied to the nozzle portions 231 to 238 and 241 to 248 are represented by initial letters C, M, Y, and K for easy understanding.

As illustrated in FIG. 3, the nozzle portions 231 to 238 of the head 23 are provided at a lower portion of the head 23 facing the medium M. Although not illustrated, the head 23 has piezoelectric elements corresponding to respective nozzles included in the nozzle portions 231 to 238. When the piezoelectric elements are driven, the inks are ejected from the nozzles.

As illustrated in FIG. 4, the nozzle portions 231 to 238 are provided side by side in the Y direction. The nozzle portions 231, 232, 233, and 234 are arranged from a Y-direction center Yo toward the Y1 side of the head 23. The nozzle portions 235, 236, 237, and 238 are arranged from the Y-direction center Yo toward the Y2 side of the head 23. The nozzle portions 231 and 235 eject black inks. The nozzle portions 232 and 236 eject yellow inks. The nozzle portions 233 and 237 eject cyan inks. The nozzle portions 234 and 238 eject magenta inks. That is, in the head 23, the nozzle portions 231 to 238 are arranged such that the nozzle portions that eject the same color ink are positioned line-symmetrically with respect to the Y-direction center Yo.

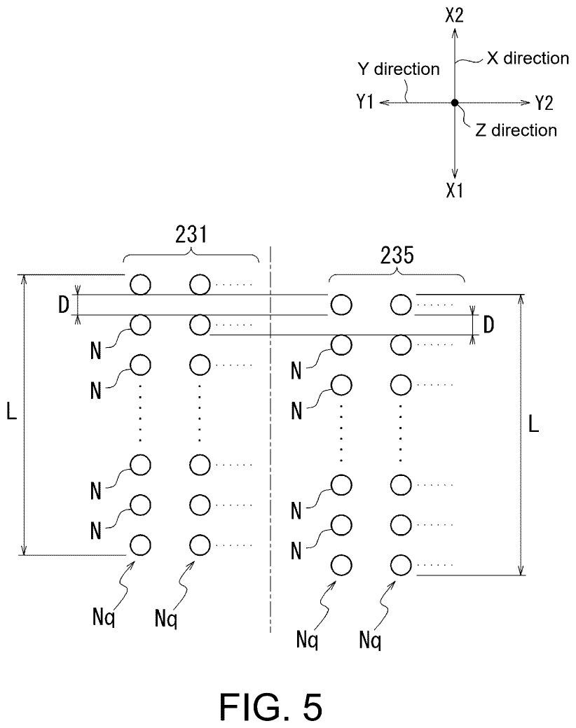

FIG. 5 is a view schematically illustrating arrangement of nozzles N constituting the nozzle portions 231 and 235.

As illustrated in FIG. 5, each of the nozzle portions 231 and 235 includes a plurality of nozzle rows Nq. Each nozzle row Nq includes a plurality of nozzles N arranged at regular intervals D in the X direction. Each nozzle row Nq has a length L in the X direction. The plurality of nozzle rows Nq is arranged at intervals in the Y direction.

The nozzles N of the nozzle portions 231 and 235 are arranged to have phases different from each other in the X direction. That is, the nozzles N of the nozzle portions 231 and 235 are alternately arranged in the X direction. When viewed in the Y direction, the nozzles N constituting the nozzle part 235 are positioned in respective intervals D between the nozzles N constituting the nozzle part 231. That is, when viewed in the Y direction, the nozzles N of the nozzle portions 231 and 235 that eject the same color ink are continually arranged in the X direction.

Although not illustrated, the other nozzle portions also have the same configuration as that of the nozzle portions 231 and 235. Further, similarly to the nozzle portions 231 and 235, the nozzle portions (the nozzle portions 232 and 236; the nozzle portions 233 and 237; and the nozzle portions 234 and 238) that eject the respective same color inks are arranged such that the nozzles of the nozzle portions have phases different from each other in the X direction.

As illustrated in FIG. 4, the nozzle portions 241 to 248 of the head 24 have the same configuration as that of the nozzle portions 231 to 238 of the head 23, and thus the detailed description thereof will be omitted. Similarly to the head 23, in the head 24, the nozzle portions 241 to 248 are arranged such that the nozzle portions that eject the same color ink are positioned line-symmetrically with respect to the Y-direction center Yo. The nozzle portions 241 and 245 eject black inks. The nozzle portions 242 and 246 eject yellow inks. The nozzle portions 243 and 247 eject cyan inks. The nozzle portions 244 and 248 eject magenta inks. The nozzle portions (the nozzle portions 241 and 245; the nozzle portions 242 and 246; the nozzle portions 243 and 247; and the nozzle portions 244 and 248) that eject the same color inks, respectively, are arranged such that the nozzles of the nozzle portions have phases different from each other in the X direction.

A configuration provided here is merely an example, and the setting of the head, the nozzle portions, the nozzle rows, the number of nozzles, the number of ink colors, the assignment of ink colors to respective nozzle portions, and the like can be changed, as appropriate.

When the head portion 22 is viewed in the Y direction, the nozzle portions 231 to 238 of the head 23 and the nozzle portions 241 to 248 of the head 24 are continuous in the X direction. Although the heads 23 and 24 are arranged at positions shifted in the Y direction, the heads 23 and 24 can eject inks at the same position in the Y direction by causing the moving mechanism 29 (see FIG. 2) to move the head portion 22 in the Y direction. That is, the nozzle portions of the head 23 including the nozzle rows Nq (see FIG. 5) having the length L and the nozzle portions of the head 24 can be regarded as constituting one nozzle row having a length 2L continuous in the X direction.

Specifically, a combination of the nozzle portions positioned at the same distance from the Y-direction center Yo in the heads 23 and 24, respectively, constitutes one nozzle row continuous in the X direction. As illustrated in FIG. 4, combinations of the nozzle part 231 and the nozzle part 241, the nozzle part 232 and the nozzle part 242, the nozzle part 233 and the nozzle part 243, the nozzle part 234 and the nozzle part 244, the nozzle part 235 and the nozzle part 245, the nozzle part 236 and the nozzle part 246, the nozzle part 237 and the nozzle part 247, and the nozzle part 238 and the nozzle part 248 each form one nozzle row continuous in the X direction.

As illustrated in FIG. 4, the head 23 has a tilt shaft TA in the Z direction. The head 23 and the head 24 are provided to be pivotable about the tilt shaft TA by a tilt mechanism (not illustrated). The tilt shaft TA is provided in an end region 23a of the head 23 on the X2 side. The tilt shaft TA is provided in the vicinity of a corner on the Y2 side in the end region 23a.

As illustrated in FIG. 3, a tilt adjusting knob 225 (hereinafter, simply referred to as a “knob 225”) of the head 23 is provided on a front surface of the head 23. The knob 225 is interlocked with a tilt mechanism (not illustrated). When the knob 225 is moved clockwise, the head 23 is pivoted clockwise (see FIG. 4). When the knob 225 is moved counterclockwise, the head 23 is pivoted counterclockwise (see FIG. 4).

The knob 225 can be, for example, a dial knob that gives a click feeling whenever the knob is pivoted by a predetermined angle.

As illustrated in FIG. 4, similarly to the head 23, the head 24 also has a tilt shaft TA in the vicinity of a corner on the Y2 side in the end region 24a on the X2 side.

The head 24 also has a tilt mechanism (not illustrated), and is pivotable about the tilt shaft TA similarly to the head 23.

As illustrated in FIG. 3, the knob 225 having the same function as the knob 225 of the head 23 is provided on a front surface side of the head 24.

The head 24 further has a displacement mechanism (not illustrated) such as a slider that displaces the head 24 in the X direction. In addition to the knob 225, a displacement adjusting knob 226 (hereinafter, simply referred to as a “knob 226”) is provided on the front surface side of the head 24. The knob 226 is interlocked with the displacement mechanism (not illustrated). For example, when the knob 226 is moved clockwise, the head 24 is displaced toward the X2 side in the X direction (see FIG. 4). When the knob 226 is moved counterclockwise, the head 24 is displaced toward the X1 side in the X direction (see FIG. 4). The knob 226 can be, for example, a dial knob that gives a click feeling whenever the knob is pivoted by a predetermined angle.

The tilt mechanisms of the heads 23 and 24 and the displacement mechanism of the head 24 are provided, for example, for performing work such as inspection, cleaning, and replacement of nozzles. After the work, the head 23 and the head 24 are adjusted by the knob 225 so that both the heads are in a state without at a tilt. The state without a tilt is a state in which the nozzle rows Nq of the heads 23 and 24 are all parallel to the X direction.

Further, position adjustment of the head 24 in the X direction is performed by the knob 226 such that the end region 24a of the head 24 overlaps the head 23 when viewed in the Y direction.

The position adjustment of the heads 23 and 24 in this manner causes dot positions of the heads 23 and 24 to coincide with each other.

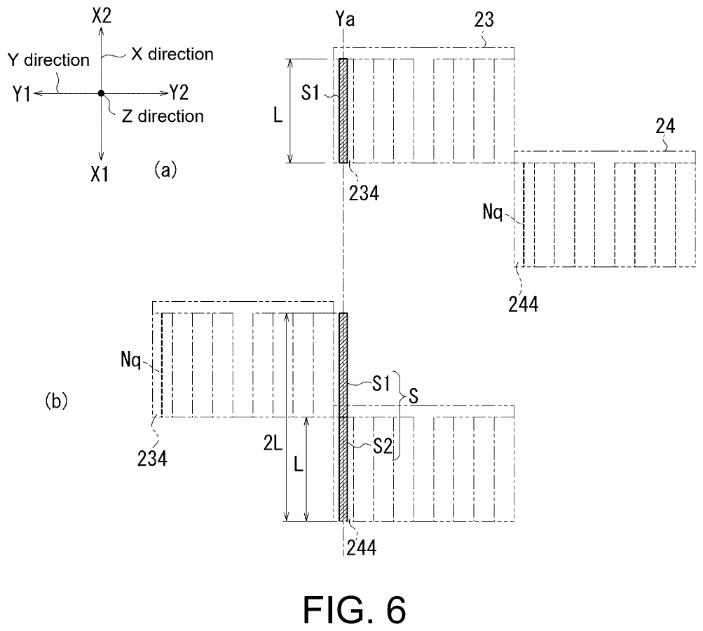

FIG. 6 is a view illustrating a printing example in the case where the dot positions of the heads 23 and 24 coincide with each other.

FIG. 6 illustrates an example in which one continuous line S is formed by the heads 23 and 24 at a position Ya in the Y direction.

As described above, in the case where printing is performed on the medium M, the controller 27 controls the moving mechanism 29 to move the heads 23 and 24 to the dot positions contained in the print data, and causes the nozzles to eject inks.

For example, as illustrated in (a) of FIG. 6, an ink is ejected from the nozzle part 234 of the head 23 at the position Ya in the Y direction to form a line S1 parallel to the X direction. The line S1 has a length L corresponding to the length in the X direction of each of the nozzle rows Nq constituting the nozzle part 234. Subsequently, as illustrated in (b) of FIG. 6, the nozzle part 244 of the head 24 is moved to the position Ya in the Y direction to eject an ink, and a line S2 parallel to the X direction is formed. The line S2 has a length L in the X direction which corresponds to each of the nozzle rows Nq constituting the nozzle part 244. The X1 side of the line S1 formed by the nozzle part 234 and the X2 side of the line S2 formed by the nozzle part 244 are connected. As a result, the line S having the length 2L continuous in the X direction is formed.

As described above, the nozzle portions of the heads 23 and 24 can be treated as one nozzle row continuous in the X direction by ejecting an ink while the heads 23 and 24 are moved from the Y2 side to the Y1 side in the Y direction, However, in the case where the dot positions of the heads 23 and 24 do not coincide with each other, continuity between the nozzle portions of the heads 23 and 24 may be affected.

A user visually adjusts the positions of the heads 23 and 24. Therefore, the heads 23 and 24 may be at a tilt and a positional misalignment which are difficult to discern with naked eyes. Alternatively, manufacturing errors, wear, or the like of the heads 23 and 24 may cause a tilt and a positional misalignment. In these cases, even if the controller 27 controls the heads 23 and 24 to eject the inks to the same dot positions on the print data, positions (actual dot positions) where the inks ejected from the heads 23 and 24 land may be misaligned. In a case where ink landing positions (actual dot positions) of the heads 23 and 24 do not coincide, the continuity between the nozzle portions of the head 23 and the nozzle portions of the head 24 may be affected, and the quality of the printed material may be affected.

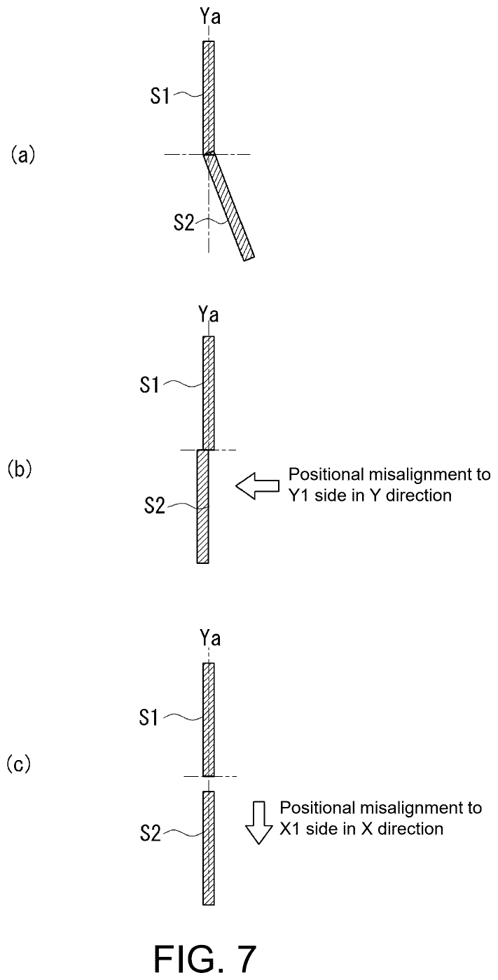

FIG. 7 is a view illustrating a printing example in a case where the dot positions of the heads 23 and 24 do not coincide. Similarly to FIG. 6, FIG. 7 illustrates an example in which the line S1 is formed by the nozzle part 234 of the head 23 and the line S2 is formed by the nozzle part 244 of the head 24 at the position Ya in the Y direction. FIG. 7 exaggeratedly illustrates the tilt and the positional misalignment of the lines S1 and S2.

Here, (a) of FIG. 7 is a view illustrating the printing example in the case where the head 24 is at a counterclockwise tilt.

In this case, the line S2 formed in the head 24 is also inclined and becomes non-parallel to the X direction.

In addition, (b) of FIG. 7 is a view illustrating a printing example in the case where the positional misalignment in the Y direction occurs in the heads 23 and 24.

In (b) of FIG. 7, a case where the dot positions of the head 24 are misaligned to the Y1 side in the Y direction with respect to the dot position of the head 23.

The line S1 formed by the head 23 is located at the position Ya in the Y direction, while the line S2 formed by the head 24 is located closer to the Y1 side than Ya.

In addition, (c) of FIG. 7 is a view illustrating a printing example in a case where the positional misalignment in the X direction occurs in the heads 23 and 24.

In (c) of FIG. 7, a case where the dot position of the head 24 is misaligned to the X1 side in the X direction with respect to the dot position of the head 23. In this case, when viewed in the Y direction, a gap is generated between the line S1 formed by the head 23 and the line S2 formed by the head 24.

As described above, in any example illustrated in FIG. 7, the line S having the length 2L continuous in the X direction as illustrated in FIG. 6 is not appropriately formed. That is, in the case where the dot positions of both the heads 23 and 24 do not coincide with each other due to the tilt or the positional misalignment of the heads 23 and 24, the quality of the printed material formed by the heads 23 and 24 may be affected.

In this embodiment, the controller 27 executes a correction mode for correcting the tilt and the positional misalignment of the heads 23 and 24. The correction mode is executed, for example, when the user selects the correction mode from a menu displayed on the operation panel 26.

The controller 27 prints the following test pattern on the medium M in the correction mode.
Test Pattern 50 for Tilt Correction
Test Pattern 60 for Positional Misalignment Correction in Y Direction
Test Pattern 70 for Positional Misalignment Correction in X Direction

The correction using the test patterns 50, 60, and 70 can be performed, for example, in the following procedure.

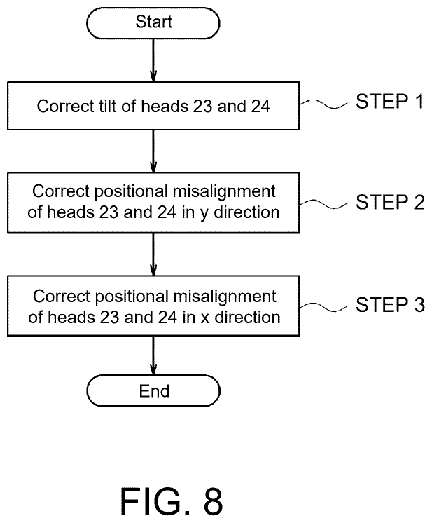

FIG. 8 is a flowchart illustrating an example of the procedure of the correction.

First, tilts of the heads 23 and 24 are corrected using the test pattern 50 (STEP 1).

Next, positional misalignments of the heads 23 and 24 in the Y direction are corrected using the test pattern 60 (STEP 2).

Next, positional misalignments of the heads 23 and 24 in the X direction are corrected using the test pattern 70 (STEP 3).

Hereinafter, details of the test patterns and a correction method using the test patterns will be described.

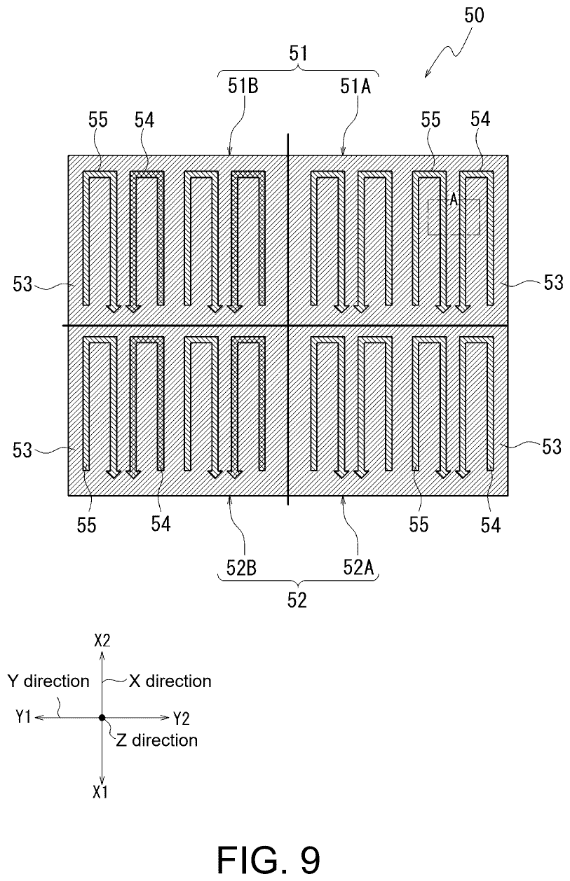

FIG. 9 is a view illustrating the test pattern 50 for tilt correction.

The X, Y, and Z directions in FIG. 9 represent directions when the medium M is positioned on the platen 21 (see FIG. 1).

As illustrated in FIG. 9, the test pattern 50 for tilt correction is divided into both a region 51 formed by the head 23 and a region 52 formed in the head 24. The region 51 is divided into both a region 51A for coarse adjustment and a region 51B for fine adjustment. The region 52 is divided into both a region 52A for coarse adjustment and a region 52B for fine adjustment.

The region 51A for coarse adjustment is a black pattern formed by the nozzle part 231 (first nozzle part) and the nozzle part 235 (second nozzle part) (see FIG. 4) of the head 23.

The region 51B for fine adjustment is a magenta pattern formed by the nozzle part 234 (third nozzle part) and the nozzle part 238 (fourth nozzle part) (see FIG. 4) of the head 23.

The region 52A for coarse adjustment is a black pattern formed by the nozzle part 241 (first nozzle part) and the nozzle part 245 (second nozzle part) (see FIG. 4) of the head 24.

The region 52B for fine adjustment is a magenta pattern formed by the nozzle part 244 (third nozzle part) and the nozzle part 248 (fourth nozzle part) (see FIG. 4) of the head 24.

That is, the four regions are formed by a combination of the nozzle portions that eject the same color inks in both the heads 23 and 24.

Each of the regions 51A, 51B, 52A, and 52B has a configuration in which a counterclockwise arrow 54 (first figure) and a clockwise arrow 55 (second figure) are arranged side by side in a rectangular base 53. As described above, each of the regions 51A, 51B, 52A, and 52B is made of the same color ink, but the base 53 and the arrows 54 and 55 are hatched differently in FIG. 9 for easy understanding.

Since the regions 51A, 51B, 52A, and 52B have the same configuration, the configuration of the region 51A will be described in detail as a representative.

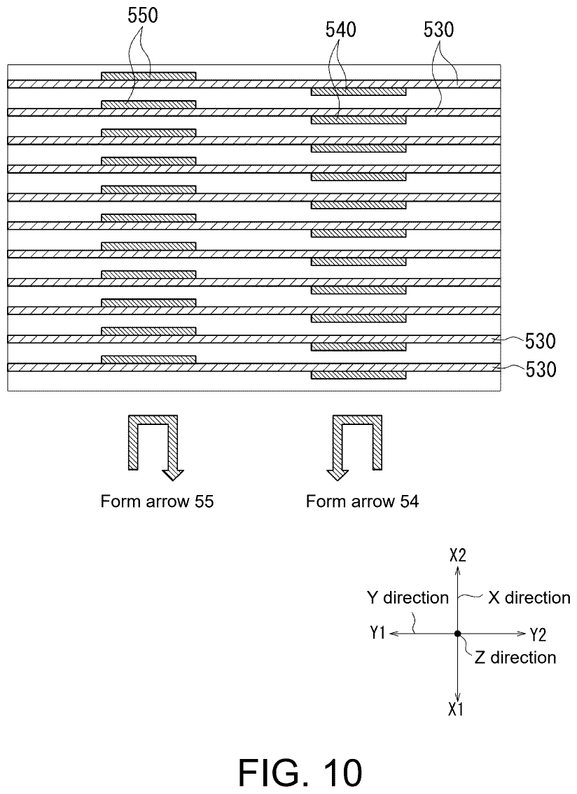

FIG. 10 is an enlarged view of a portion surrounded by box A in FIG. 9.

The base 53 illustrated in FIG. 9 includes a set of a plurality of base lines 530 (first base lines) extending in the Y direction illustrated in FIG. 10. Since the plurality of base lines 530 are arranged in the X direction at slight intervals from each other, the base lines are visually recognized as a rectangular base 53 as a whole.

The arrows 54 and 55 illustrated in FIG. 9 include a set of a plurality of rectangular blocks 540 (first blocks) and a set of blocks 550 (second blocks) illustrated in FIG. 10, respectively. The blocks 540 and 550 are formed between the plurality of base lines 530. The blocks 540 and 550 are formed at intervals in the Y direction. Consequently, the arrow 54 that is the set of the blocks 540 and the arrow 55 that is the set of the blocks 550 are arranged to be shifted in position so as not to overlap each other in the Y direction.

Each of the blocks 540 constituting the arrow 54 is formed adjacent to each of the base lines 530 on the X1 side (lower side in the drawing) of the base line 530. The set of the plurality of the blocks 540 is visually recognized as the counterclockwise arrow 54.

Each of the blocks 550 constituting the arrow 55 is formed adjacent to each of the base lines 530 on the X2 side (upper side in the drawing). The set of the plurality of blocks 550 is visually recognized as the clockwise arrows 55.

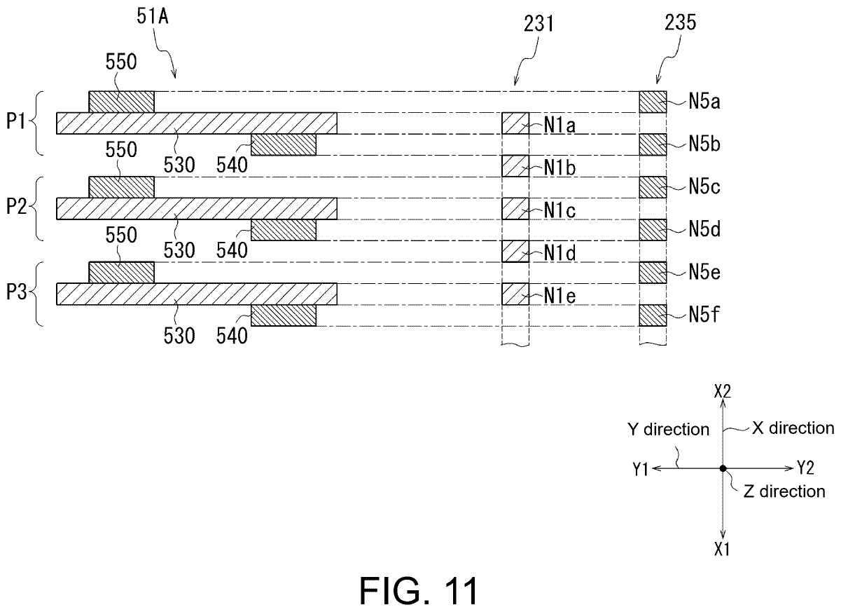

FIG. 11 is a view illustrating a method of forming the test pattern 50.

FIG. 11 illustrates a method of forming the region 51A as an example. The base lines 530 in the region 51A are formed by the nozzle part 231 of the head 23. The blocks 540 and 550 are formed by the nozzle part 235 of the head 23. FIG. 11 schematically illustrates arrangement of the nozzles constituting the nozzle portions 231 and 235 and correspondence between the base lines 530 and the blocks 540 and 550 formed by the respective nozzles. In FIG. 11, the nozzles are represented by rectangles for easy understanding.

As illustrated in FIG. 11, nozzles N1a, N1b, N1c, N1d, N1e, . . . of the nozzle part 231 are arranged from the X2 side toward the X1 side in the X direction.

Nozzles N5a, N5b, N5c, N5d, N5e, N5f, . . . of the nozzle part 235 are arranged from the X2 side toward the X1 side in the X direction. The nozzles of the nozzle part 235 are arranged to have a phase shift in the X direction with respect to the nozzles of the nozzle part 231. That is, the nozzles of the nozzle part 231 and the nozzles of the nozzle part 235 are alternately positioned in the X direction.

FIG. 11 illustrates three combinations P1, P2, and P3 of the base lines 530 and the blocks 540 and 550.

In the combination P1, the base line 530 is formed by the nozzle N1a (first nozzle). The block 540 is formed by the nozzle N5b (second nozzle) positioned on the X1 side of the nozzle N1a. The block 550 is formed by the nozzle N5a (third nozzle) positioned on the X2 side of the nozzle N1a.

Consequently, the blocks 540 and 550 are formed adjacent to each other on the X1 side and the X2 side of the base line 530, respectively. The combination P1 has a width corresponding to three dots in the X direction.

An interval corresponding to one dot is provided between the combination P1 and the combination P2. That is, the ink is not ejected from the nozzle N1b.

The base line 530 of the combination P2 is formed by the nozzle N1c (first nozzle). The block 540 is formed by the nozzle N5d (second nozzle) positioned on the X1 side of the nozzle N1c. The block 550 is formed by the nozzle N5c (third nozzle) positioned on the X2 side of the nozzle N1c.

An interval corresponding to one dot is provided between the combination P2 and the combination P3. That is, the ink is not ejected from the nozzle N1d.

The base line 530 of the combination P3 is formed by the nozzle N1e (first nozzle). The block 540 is formed by the nozzle N5f (second nozzle) on the X1 side of the nozzle N1e. The block 550 is formed by the nozzle N5e (third nozzle) on the X2 side of the nozzle N1e.

Similarly to the combination P1, the combinations P2 and P3 also have a width corresponding to three dots in the X direction.

As described above, the base line 530 is formed using every other nozzle of the nozzle part 231. The block 540 is formed by a nozzle of the nozzle part 235 which is adjacent to a nozzle of the nozzle part 231 forming the base line 530 and is positioned on one side (X1 side) in the X direction with respect to the nozzle of the nozzle part 231. The block 550 is formed by a nozzle of the nozzle part 235 which is adjacent to a nozzle of the nozzle part 231 forming the base line 530 and is positioned on the other side (X2 side) in the X direction with respect to the nozzle of the nozzle part 231. That is, the blocks 540 and 550 are shifted in positions from each other in the X direction and arranged so as not to overlap each other.

FIG. 11 illustrates the test pattern 50 formed in a state in which the head 23 is not tilted. As illustrated in FIG. 4, the nozzle part 231 forming the base line 530 is farther apart from the tilt shaft TA than the nozzle part 235 forming the blocks 540 and 550. Details will be described below, and a positional relationship between the base line 530 and the blocks 540 and 550 changes due to a difference in distance from the tilt shaft TA when the head 23 is at a tilt.

The other regions are also formed in the same method of forming the region 51A.

In the region 51B for fine adjustment illustrated in FIG. 9, the base 53 (base lines 530, second base lines) is formed by the nozzle part 234 (third nozzle part) of the head 23. The arrow 54 (blocks 540, third blocks) and the arrow 55 (blocks 550, fourth blocks) are formed by the nozzle part 238 (fourth nozzle part).

In the region 52A for coarse adjustment a, the base 53 (base lines 530, first base lines) is formed by the nozzle part 241 (first nozzle part) of the head 24. The arrow 54 (blocks 540, first blocks) and the arrow 55 (blocks 550, second blocks) are formed by the nozzle part 245 (second nozzle part).

In the region 52B for fine adjustment, the base 53 (base lines 530, second base lines) is formed by the nozzle part 244 (third nozzle part) of the head 24. The arrow 54 (blocks 540, third blocks) and the arrow 55 (blocks 550, fourth blocks) are formed by the nozzle part 248 (fourth nozzle part).

As described above, in any region, the base 53 (base lines 530) is formed by the nozzle part distant from the tilt shaft TA, and the arrows 54 and 55 (blocks 540 and 550) are formed by the nozzle part close to the tilt shaft TA.

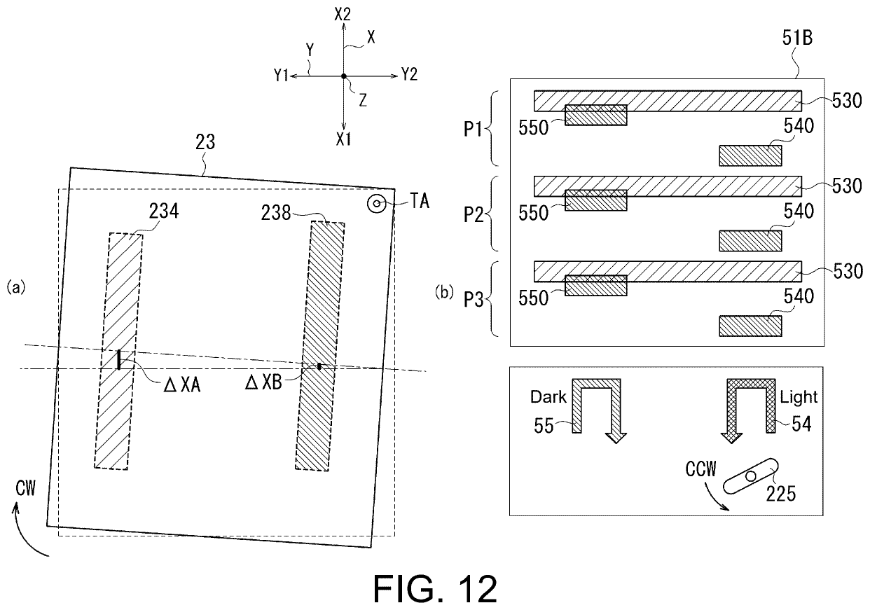

FIG. 12 is a view for illustrating a change in the test pattern 50 in the case where the head 23 is at a tilt.

Here, (a) of FIG. 12 is a view illustrating displacement of the nozzle portions 234 and 238 in a case where the head 23 is at a tilt in a clockwise direction CW. In (a) of FIG. 12, the nozzle portions 234 and 238 having a long distance between the nozzle portions are illustrated so that an effect of the tilt of the head 23 can be easily understood. In addition, (a) of FIG. 12 schematically illustrates a positional relationship between the nozzle portions 234 and 238 for easy understanding.

In addition, (b) of FIG. 12 is a view for illustrating a change in the region 51B formed by the nozzle portions 234 and 238 in a case where the head 23 is at a tilt in the clockwise direction CW.

In (a) of FIG. 12, the head 23 without a tilt is represented by a broken line, and the head 23 at a tilt in the clockwise direction CW is represented by a solid line. As illustrated in (a) of FIG. 12, in the case where the head 23 is at a tilt in the clockwise direction CW, the nozzle portions 234 and 238 provided in the head 23 are displaced to the X2 side in the X direction.

As illustrated in (b) of FIG. 12, the base lines 530 and the blocks 540 and 550 formed by the nozzle portions 234 and 238 are also displaced in the X direction depending on displacement of the nozzle portions.

Although the nozzle portions 234 and 238 are also displaced in the Y direction due to the tilt of the head 23, in (b) of FIG. 12, the base lines 530 and the blocks 540 and 550 are illustrated in parallel with the Y direction while the displacement thereof in the Y direction is ignored for easy understanding.

As illustrated in (a) of FIG. 12, when the head 23 is pivoted, a displacement amount in the X direction increases as the nozzle part is farther apart from the tilt shaft TA which is a pivoting center. A displacement amount AXA in the X direction of the nozzle part 234 far apart from the tilt shaft TA is larger than a displacement amount AXB in the X direction of the nozzle part 238 close to the tilt shaft TA (AXA>AXB).

A difference between the displacement amounts of the nozzle portions 234 and 238 is also reflected in the displacement amounts of the base lines 530 and the blocks 540 and 550 formed by these nozzle portions in the X direction. That is, the displacement amount of the base line 530 in the X direction is larger than those of the blocks 540 and 550. Therefore, as illustrated in (b) of FIG. 12, the base lines 530 of the combinations P1 to P3 are relatively displaced to the X2 side with respect to the blocks 540 and 550 in the same combinations. As illustrated in FIG. 11, in the state in which the head 23 is not tilted, the base line 530 is located between the blocks 540 and 550. As illustrated in (b) of FIG. 12, when the base line 530 is displaced to the X2 side, the base line 530 of the combination P1 is separated from the block 540 of the same combination P1 and partially overlaps the block 550. Similar changes occur in the combinations P2 and P3. This change in the relative positions between the base line 530 and the blocks 540 and 550 is observed in the entire region 51B.

Here, in human vision, in the same area, when the lines are separated from each other, a color thereof looks darker, and when the lines are close to each other or are in contact with each other, the color thereof looks lighter.

That is, a phenomenon occurs in which the arrow 54, which is a set of the blocks 540 separated from the base lines 530, looks darker than the arrow 55, which is a set of the blocks 550 partially overlapping the base lines 530.

Here, in (a) of FIG. 12, since the head 23 is at a tilt in the clockwise direction CW, it is necessary to turn the knob 225 in a counterclockwise direction CCW in order to adjust the tilt of the head 23. As illustrated in (b) of FIG. 12, the user can correct the tilt of head 23 by turning the knob 225 in the counterclockwise direction CCW according to the direction represented by the arrow 54 that looks dark.

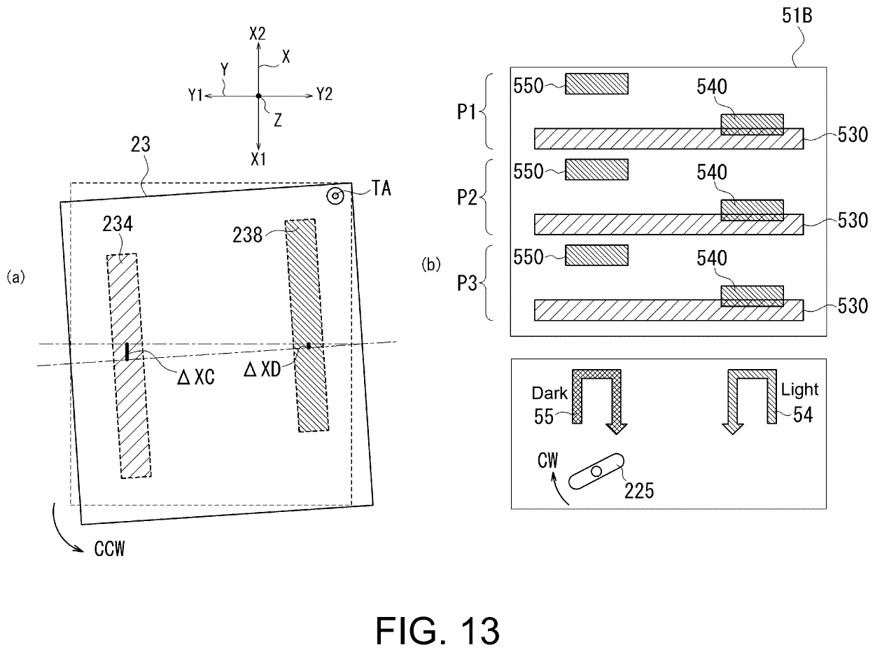

FIG. 13 is a view for illustrating a change in the test pattern 50 in a case where the head 23 is at a tilt.

Here, (a) of FIG. 13 is a view schematically illustrating displacement of the nozzle portions 234 and 238 in a case where the head 23 is at a tilt in the counterclockwise direction CCW. In addition, (b) of FIG. 13 is a view for illustrating a change in the test pattern 50 and a pivoting direction of the knob 225 in the case where head 23 is at a tilt in the counterclockwise direction CCW. In (b) of FIG. 13, similarly to (b) of FIG. 12, the base lines 530 and the blocks 540 and 550 are illustrated in parallel with the Y direction, while the displacement in the Y direction is ignored.

As illustrated in (a) of FIG. 13, in the case where the head 23 is at a tilt in the counterclockwise direction CCW, the nozzle portions 234 and 238 provided in the head 23 are displaced to the X1 side in the X direction. A displacement amount AXC in the X direction of the nozzle part 234 far apart from the tilt shaft TA is larger than a displacement amount AXD in the X direction of the nozzle part 238 close to the tilt shaft TA (AXC>AXD).

As illustrated in (b) of FIG. 13, the base line 530 is relatively displaced to the X1 side with respect to the blocks 540 and 550. The base lines 530 of the combinations P1 to P3 are separated from the blocks 550 of the same combinations and partially overlap the blocks 540. This causes a phenomenon in which the arrow 55, which is a set of the blocks 550, looks darker than the arrow 54, which is a set of the blocks 540.

Here, in (a) of FIG. 13, since the head 23 is at a tilt in the counterclockwise direction CCW, it is necessary to turn the knob 225 in the clockwise direction CW in order to adjust the tilt of the head 23. That is, the user can correct the tilt of head 23 by pivoting the knob 225 in the clockwise direction CW according to the direction represented by the arrow 55 that looks dark.

As described above, the blocks 540 and 550 are formed on the X1 and X2 sides of the base line 530, respectively. Further, as the nozzle part that forms the blocks 540 and 550, a nozzle part closer to the tilt shaft TA than the nozzle part that forms the base line 530 is used. Consequently, there is a difference in the displacement amount between the base line 530 and the blocks 540 and 550 when the head 23 is at a tilt, and the base line 530 is displaced relative to the blocks 540 and 550. The base line 530 is displaced to either the X1 side or the X2 side according to a direction of the tilt of the head 23, and there is a difference in distance from both the blocks 540 and 550. This difference in distance causes a difference in density between the arrows 54 and 55. The user can discern whether a correction direction of the tilt of the head 23 is the X2 side (clockwise direction CW) or the X1 side (counterclockwise direction CCW).

Here, the individual base lines 530 and blocks 540, 550 are very small. For example, in a case where only one combination P1 of the base line 530 and the blocks 540 and 550 is printed on the medium M, a loupe is required to discern a difference in distance therebetween.

In the embodiment, combinations of a plurality of base lines 530 and blocks 540 and 550 are printed, and the arrows 54 and 55, which are sets of the blocks 540 and 550, respectively, are formed in the base 53, which is a set of the base lines 530. Here, in human vision, in the same area, when the lines are separated from each other, a color thereof looks darker, and when the lines are close to each other or are in contact with each other, the color thereof looks lighter. In the arrows 54 and 55, which are an aggregate of lines, it is easier to visually recognize this difference in density.

In the embodiment, figures formed by the sets of the blocks 540 and 550 are the arrows 54 and 55 representing a correction direction of a tilt of the head 23 (the pivoting direction of the tilt shaft TA). That is, the arrow 54 that becomes darker due to the tilt of the head 23 toward the X2 side (clockwise direction CW) is displayed as the counterclockwise direction CCW. The arrow 55 that becomes darker due to the tilt of the head 23 to the X1 side (counterclockwise direction CCW) is displayed as the clockwise direction CW.

For example, in a case where only one combination P1 of the base line 530 and the blocks 540 and 550 is printed on the medium M, it is difficult to intuitively discern, from a difference in distance therebetween, a direction in which the knob 225 is turned. An indication of a direction opposite to a direction of a tilt of the head 23, that is, a correction direction, is assigned to the arrow 54 or 55 that appears darker according to the direction of the tilt of the head 23, and thereby the user can intuitively discern the direction in which the knob 225 is to be turned.

In the test pattern 50, the region 51 indicating a tilt of the head 23 and the region 52 indicating a tilt of the head 24 are formed on the same medium M. Therefore, the user can adjust both the heads 23 and 24 from one test pattern 50.

In the state in which the heads 23 and 24 are not tilted, there is no difference in density between the arrows 54 and 55. The user pivots the knob 225 depending on the difference in density between the arrows 54 and 55, prints test pattern 50 again, and checks the change in density between the arrows 54 and 55. The user repeats the pivoting, the printing, and the checking, and adjusts the heads 23 and 24 until there is no difference in density between the arrows 54 and 55.

As illustrated in FIG. 9, the region 51 of the test pattern 50 is divided into both the region 51A for coarse adjustment and the region 51B for fine adjustment. The region 52 is also divided into both the region 52A for coarse adjustment and the region 52B for fine adjustment. The user performs coarse adjustment using the regions 51A and 52A in an initial stage in which the heads 23 and 24 are at large tilts, and performs fine adjustment using the regions 51B and 52B in a stage in which the tilt correction is advanced. FIG. 9 illustrates a stage in which the tilt correction is performed using the regions 51B and 52B for fine adjustment.

The regions 51A and 52A for coarse adjustment are formed by a combination of nozzle portions having a short (close) distance in the Y direction between the nozzle portions. The regions 51B and 52B for fine adjustment are formed by a combination of nozzle portions having a long (far) distance in the Y direction between the nozzle portions. Consequently, in the regions 51B and 52B for fine adjustment, tilts of the heads 23 and 24 have stronger effects than in the regions 51A and 52A for coarse adjustment.

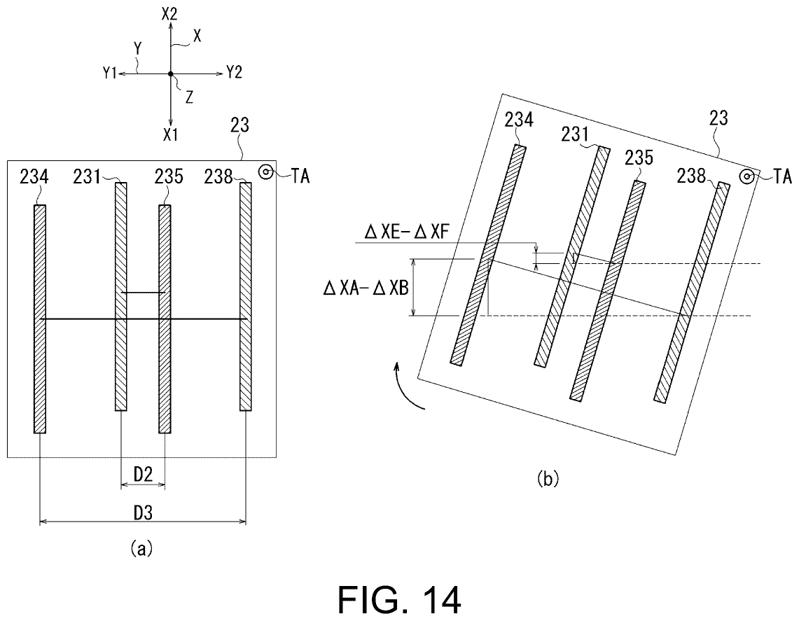

FIG. 14 is a view for illustrating a positional relationship between the nozzle portions of the head 23.

Here, (a) of FIG. 14 is a view schematically illustrating a positional relationship between the nozzle portions 231 and 235 forming the region 51A (see FIG. 9) and the nozzle portions 234 and 238 forming the region 51B (see FIG. 9), in the head 23. In addition, (b) of FIG. 14 is a view for illustrating a difference in displacement amount between the nozzle portions when the head 23 is at a tilt.

As illustrated in (a) of FIG. 14, a distance D3 between the nozzle portions 234 and 238 forming the region 51B for fine adjustment is longer than a distance D2 between the nozzle portions 231 and 235 forming the region 51A for coarse adjustment. Further, the nozzle part 234 forming the base lines 530 in the region 51B is farther apart from the tilt shaft TA than the nozzle part 231 forming the base lines 530 in the region 51A. The nozzle part 238 forming the blocks 540 and 550 in the region 51B is closer to the tilt shaft TA than the nozzle part 235 forming the blocks 540 and 550 in the region 51A.

Based on such a positional relationship, as illustrated in (b) of FIG. 14, when the head 23 is at a tilt, a difference (AXA-AXB) in the displacement amount in the X direction between the nozzle portions 234 and 238 is larger than a difference (AXE-AXF) in the displacement amount in the X direction between the nozzle portions 231 and 235. Based on the differences in the displacement amounts, when the head 23 is at a tilt, the relative displacement amount between the base line 530 and the blocks 540 and 550 is larger in the region 51B than in the region 51A.

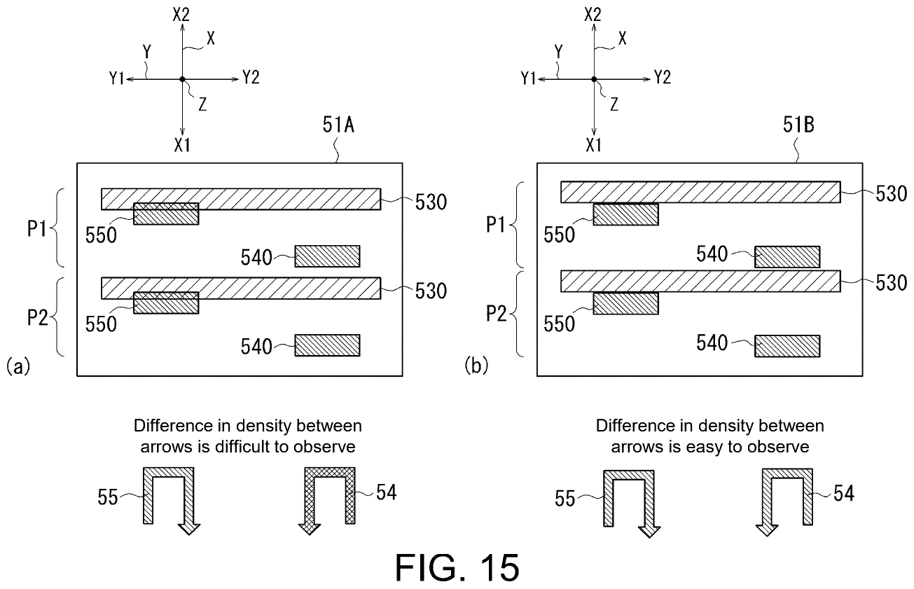

FIG. 15 is a view for illustrating displacement in the X direction in the region 51A and the region 51B in the case where the head 23 is at a large tilt. Here, (a) of FIG. 15 illustrates the region 51A, and (b) of FIG. 15 illustrates the region 51B. FIG. 15 illustrates a case where the head 23 is at a clockwise tilt.

As illustrated in (a) of FIG. 15, in a stage in which the head 23 is at a large tilt, the base lines 530 are relatively significantly displaced to the X2 side also in the region 51A. The base lines 530 of the combinations P1 and P2 partially overlap the blocks 550 in the same combinations and are separated from the blocks 540. Consequently, the arrow 54 corresponding to a turning direction (counterclockwise direction) of the knob 225 appears dark.

On the other hand, in the region 51B, the base lines 530 are displaced to the X2 side more significantly than in the region 51A. The base lines 530 of the combinations P1 and P2 do not overlap the blocks 550 in the same combinations. Further, the base line 530 of the combination P2 approaches the block 540 of the other combination P1. Consequently, a difference in density between the arrows 54 and 55 is difficult to be clarified, or the arrow 55 opposite to the turning direction (counterclockwise direction) of the knob 225 may appear dark.

Therefore, in an initial stage in which the head 23 is at a large tilt, coarse adjustment is performed using the region 51A that is less affected by the tilt of the head 23.

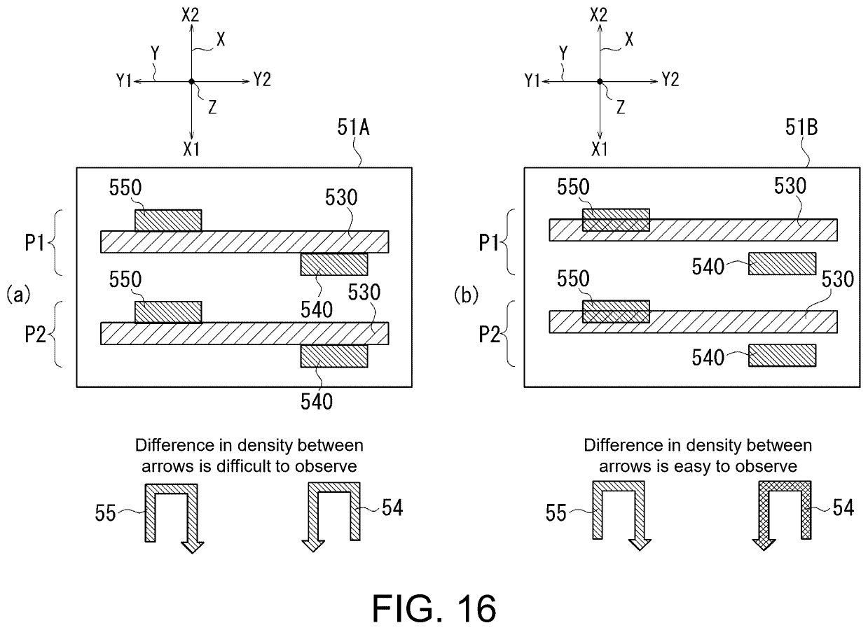

FIG. 16 is a view for illustrating displacement of the region 51A and the region 51B in the X direction in a case where the head 23 is at a small tilt. Here, (a) of FIG. 16 illustrates the region 51A, and (b) of FIG. 16 illustrates the region 51B. FIG. 16 illustrates a case where the head 23 is at a clockwise tilt.

When the tilt of the head 23 decreases as the coarse adjustment progresses, the displacement of the base line 530 decreases in the region 51A. Since the base lines 530 of the combinations P1 and P2 do not overlap the blocks 550 and are close to the blocks 540, a difference in density between the arrows 54 and 55 is less likely to be observed.

On the other hand, in the region 51B, since the displacement of the base lines 530 is larger than that in the region 51A, the base lines 530 partially overlap the blocks 550 and are separated from the blocks 540 on the X1 side. Consequently, the arrow 54 corresponding to a turning direction (counterclockwise direction) of the knob 225 appears dark.

As described above, in the stage in which the correction of the tilt of the head 23 has progressed, the head 23 can be adjusted by a fine angle using the region 51B significantly affected by the tilt of the head 23.

Although detailed description is omitted, the head 24 can also be subjected to coarse adjustment using the region 52A and fine adjustment using the region 52B. In the test pattern 50, the regions 51A and 52A for coarse adjustment and the regions 51B and 52B for fine adjustment are printed on the same medium M. The user does not need to select the coarse adjustment mode and the fine adjustment mode to cause printing to be performed. Since the user can compare the regions 51A and 52A and the regions 51B and 52B in the test pattern 50, transition from the coarse adjustment to the fine adjustment is smoothly performed.

In the coarse adjustment and the fine adjustment, pivoting amounts of the heads 23 and 24 may vary by the knob 225.

For example, the knob 225 may be pivoted by five clicks in the coarse adjustment, whereas the knob 225 may be pivoted by three clicks in the fine adjustment.

In addition, as illustrated in FIG. 9, two sets of the arrows 54 and 55 are printed in each of the regions 51A, 51B, 52A, and 52B. In a case of only one set of the arrows 54 and 55, the difference in density is difficult to appropriately observe due to an error in some cases. In the embodiment, a plurality of sets of arrows 54 and 55 are printed in consideration of an error.

In a case where adjustment is performed using each of the regions 51A, 51B, 52A, and 52B, the user can perform adjustment such that there is no difference in density in both of the two sets of arrows 54 and 55. Three or more sets of arrows 54 and 55 may be printed in each of the regions 51A, 51B, 52A, and 52B.

When the tilt correction of the heads 23 and 24 using the test pattern 50 is completed, positional misalignment correction in the Y direction using the test pattern 60 is subsequently performed (STEP 2 in FIG. 8).

The test pattern 60 is formed by combinations of nozzle portions forming respective continuous nozzle rows in the heads 23 and 24. As described above, eight combinations are used in the embodiment, but in STEP 2, the test pattern 60 is formed using one combination of nozzle portions.

Here, an example in which the test pattern 60 is formed by a combination of the nozzle part 234 of the head 23 and the nozzle part 244 of the head 24 will be described.

The heads 23 and 24 do not include a displacement mechanism in the Y direction. In the embodiment, in a case where a positional misalignment in the Y direction is confirmed in the test pattern 60, the positional misalignment in the Y direction is corrected by correcting data of dot positions included in print data.

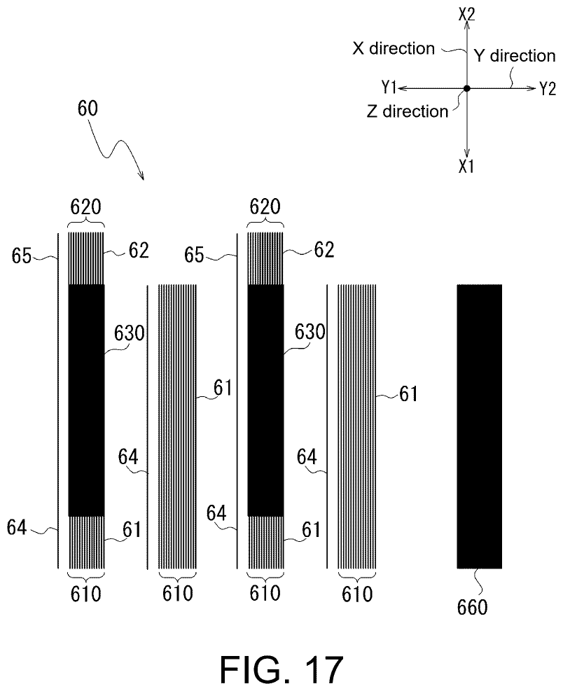

FIG. 17 is a view illustrating the test pattern 60 for positional misalignment correction in the Y direction.

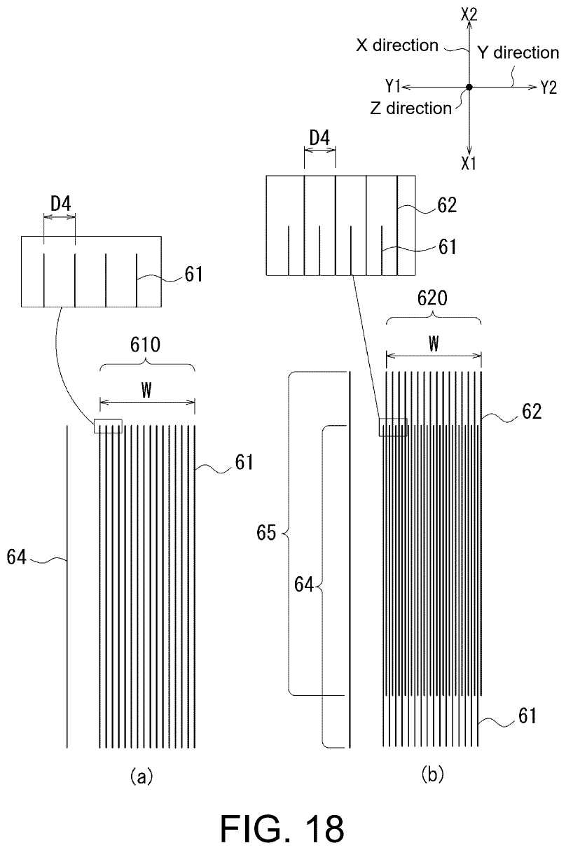

FIG. 18 is a view for illustrating a method of forming the test pattern 60. Here, (a) of FIG. 18 is a view illustrating formation of a first line portion 610. In addition, (b) of FIG. 18 is a view illustrating formation of a second line portion 620.

The X, Y, and Z directions in FIGS. 17 and 18 represent directions when the medium M is positioned on the platen 21 (see FIG. 1). FIGS. 17 and 18 illustrate the test pattern 60 formed in a state in which the dot positions of the head 23 and the head 24 coincide with each other.

As illustrated in FIG. 17, the test pattern 60 has a first line 61 formed by the nozzle part 234 of the head 23 and a second line 62 formed by the nozzle part 244 of the head 24.

As illustrated in (a) of FIG. 18, the first line 61 is a line extending parallel to the X direction. A plurality of first lines 61 are arranged at intervals D4 in the Y direction, and the first line portion 610 having a width W in the Y direction is formed.

As illustrated in FIG. 17, in the test pattern 60, the plurality of first line portions 610 are formed at intervals in the Y direction. FIG. 17 illustrates an example in which four first line portions 610 are formed.

As illustrated in (b) of FIG. 18, the second line 62 is a line extending parallel to the X direction. A plurality of second lines 62 are arranged at the intervals D4 in the Y direction, and a second line portion 620 having the width W in the Y direction is formed.

The second lines 62 are formed between the plurality of first lines 61 in the Y direction. The second line 62 is located in the interval D4 between the first lines 61 in the Y direction. The second line 62 is formed to be shifted in position to the X2 side from the first line 61 in the X direction. When viewed in the Y direction, the first line 61 and the second line 62 partially overlap each other.

That is, the test pattern 60 has an overlap portion 630 in which the first lines 61 and the second lines 62 overlap each other when viewed in the Y direction. In the overlap portion 630, the first lines 61 and the second lines 62 are alternately arranged in the Y direction. In other words, in the overlap portion 630, the second line 62 is formed to fill the interval D4 between the adjacent first lines 61.

The actual interval D4 is very small. Therefore, as illustrated in FIG. 17, in a case where the first line 61 and the second line 62 coincide with a predetermined range, the overlap portion 630 is visually recognized as a region filled with inks, that is, a solid region, with the naked eye.

As illustrated in FIG. 17, second line portions 620 are formed with respect to every other first line portion of the four first line portions 610. That is, the overlap portion 630 is formed at the two first line portions 610. The overlap portion 630 is not formed at the first line portions 610 therebetween.

As illustrated in FIG. 17, the test pattern 60 includes a first reference line 64 formed on the Y1 side of each of the first line portions 610. Similarly to the first line portion 610, the first reference line 64 is formed by the nozzle part 234 of the head 23.

As illustrated in FIG. 18, the first reference line 64 is a line extending parallel to the X direction, and has the same length in the X direction as the first line 61. The first reference line 64 is formed at the same position as the first line portion 610 in the X direction.

The test pattern 60 includes a second reference line 65 formed on the Y1 side of each of the second line portions 620. Similarly to the second line portion 620, the second reference line 65 is formed by the nozzle part 244 of the head 24.

The second reference line 65 is a line extending parallel to the X direction, and has the same length in the X direction as the second line 62. The second reference line 65 is formed at the same position as the second line portion 620 in the X direction. The second reference line 65 is formed at the same position as the first reference line 64 in the Y direction. The second reference line 65 is formed to be shifted in position to the X2 side of the first reference line 64. That is, the first reference line 64 and the second reference line 65 are partially superimposed and printed on the medium M. Consequently, the first reference line 64 and the second reference line 65 are visually recognized as one continuous line.

As illustrated in FIG. 17, the test pattern 60 includes a sample block 660. The sample block 660 is formed on the Y2 side of the first line portions 610. The sample block 660 is a so-called “solid” rectangular figure filled with a single color ink. The sample block 660 is formed only by the nozzle part 234 of the head 23. The sample block 660 is formed at the same position as the first line portion 610 in the X direction.

The test pattern 60 is formed while the heads 23 and 24 are both moved in the same direction. The first line portions 610, the first reference lines 64, and the sample block 660 of the test pattern 60 are formed, for example, by ejecting inks while the head 23 is moved from the Y2 side to the Y1 side in the Y direction. The second line portions 620 and the second reference lines 65 of the test pattern 60 are formed, for example, by ejecting ink while the head 24 is moved from the Y2 side to the Y1 side in the Y direction, similarly to the head 23.

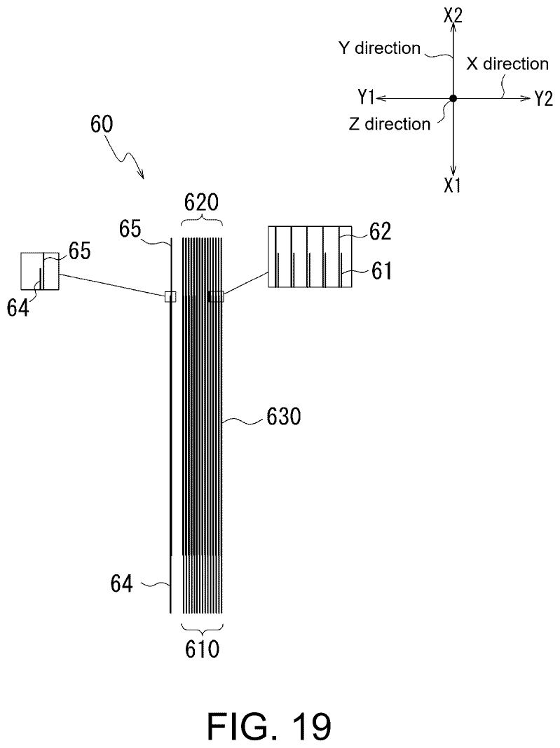

FIG. 19 is a view for illustrating a change in the test pattern 60 in a case of a positional misalignment of the heads 23 and 24 in the Y direction. FIG. 19 illustrates a case where the dot positions of the head 24 are misaligned to the Y2 side with respect to the dot positions of the head 23.

When the dot positions of the head 24 are misaligned to the Y2 side, the second lines 62 formed by the head 24 are displaced to the Y2 side.

Consequently, as illustrated in FIG. 19, in the overlap portion 630, the second lines 62 approach the first lines 61 or overlap the first lines 61. The intervals D4 between the first lines 61 are not filled with the second lines 62, and are visually recognized as portions where an ink is not ejected. In other words, the overlap portion 630 is in a state in which uneven filling occurs, and is not visually recognized as solid filling as illustrated in FIG. 19.

The user can discern that the dot positions of the head 23 and the head 24 are misaligned in the Y direction by comparing states of the solid-filled sample block 660 (see FIG. 17) and the overlap portion 630.

As illustrated in FIG. 19, when the dot positions of the head 24 are misaligned to the Y2 side, the second reference line 65 formed by the head 24 is also displaced to the Y2 side similarly to the second line 62. Consequently, the positions of the first reference line 64 and the second reference line 65 in the Y direction are misaligned, and the second reference line 65 is not superimposed on the first reference line 64 and is positioned on the Y2 side with respect to the first reference line 64. The user can discern that the dot positions of the head 24 are misaligned to the Y2 side with respect to the dot positions of the head 23 by comparing the first reference line 64 and the second reference line 65. Further, an approximate amount of misalignment of the dot positions of the head 24 can be discerned by viewing a misalignment amount of the second reference line 65 with respect to the first reference line 64.

As illustrated in FIG. 17, in the test pattern 60, the first line portion 610 in which the overlap portion 630 is not formed is provided. In a case where the overlap portion is provided in all the first line portions 610, there is a possibility that it becomes difficult to distinguish the first line portion 610 and the second line portion 620 when an orientation of the medium M changes. The user can determine the first line portion 610 and the second line portion 620 based on the first line portion 610 in which the overlap portion 630 is not formed.

Although not illustrated, the controller 27 (see FIG. 1) receives an input of a correction value for correcting the dot positions of the nozzle portions 241 to 248 of the head 24, for example, in the correction mode. For example, the controller 27 displays a correction value input portion on the operation panel 26 (see FIG. 1). The user inputs a correction value corresponding to the amount of misalignment of the dot positions of the head 24 in a misalignment direction, the shift amount being confirmed from the test pattern 60. At this time, the user may input the correction value only for the nozzle part 244 of the head 24. Alternatively, the same correction value may be input for all the nozzle portions 241 to 248 of the head 24.

The user repeats printing of the test pattern 60 and inputting of the correction value until the overlap portion 630 (see FIG. 19) is in the same solid filling state as the sample block 660 (see FIG. 17).

Consequently, the positional misalignment of the heads 23 and 24 in the Y direction can be corrected. At the time of printing, the controller 27 controls the movement of the head 24 by reflecting the correction value to the dot positions of the head 24 in the print data.

The head 24 may include a displacement mechanism in the Y direction, and the displacement mechanism may correct the positional misalignment between the head 23 and the head 24 in the Y direction.

When the positional misalignment correction of the heads 23 and 24 in the Y direction is completed, positional misalignment correction of the heads 23 and 24 in the X direction is subsequently performed using the test pattern 70 (STEP 3 in FIG. 8).

Similarly to the test pattern 60, the test pattern 70 is formed using the nozzle part 234 of the head 23 and the nozzle part 244 of the head 24.

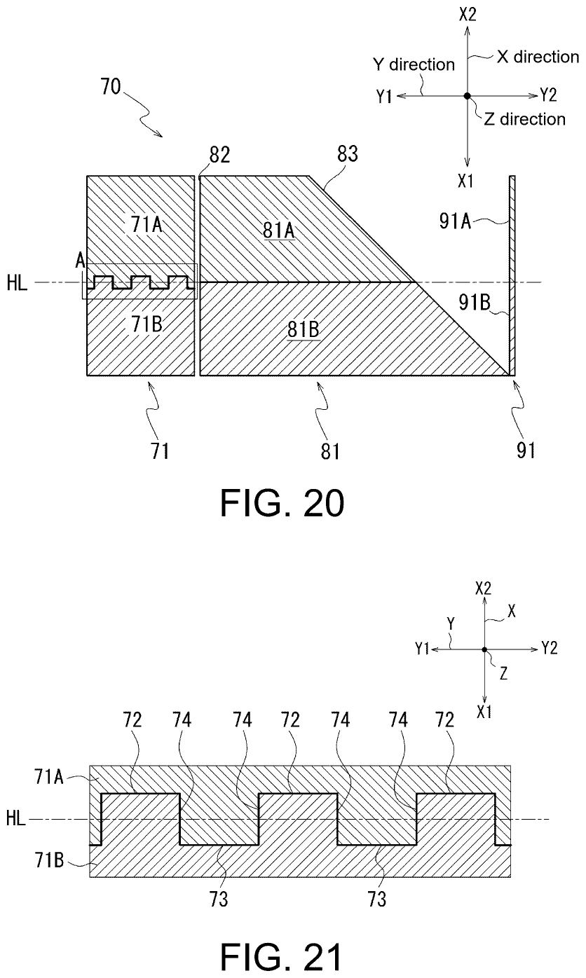

FIG. 20 is a view illustrating the test pattern 70 for the positional misalignment correction in the X direction.

The X, Y, and Z directions in FIG. 20 represent directions when the medium M is positioned on the platen 21. In addition, FIG. 20 illustrates the test pattern 70 formed in a state in which the dot positions of the nozzle portions 234 and 244 coincide with each other.

As illustrated in FIG. 20, the test pattern 70 includes three figures of a rectangular block 71, a trapezoidal block 81, and a line 91.

In each figure of the test pattern 70, a region on the X2 side is formed by the nozzle part 234 of the head 23 and a region on the X1 side is formed by the nozzle part 244 of the head 24 with a line segment HL parallel to the Y direction as a boundary. The boundary positioned on the line segment HL is not actually noticeable, and is represented by a thick line for easy understanding in FIG. 20.

In addition, in FIG. 20, different hatching is applied to the regions formed by the nozzle part 234 and the nozzle part 244 for easy understanding while the entire test pattern 70 is formed by a magenta ink.

FIG. 21 is an enlarged view of a portion surrounded by box A in FIG. 20.

The block 71 has a region 71A (first region) formed by the head 23 on the X2 side of the line segment HL. The block 71 has a region 71B (second region) formed by the head 24 on the X1 side of the line segment HL.

As illustrated in FIG. 21, at the boundary between the regions 71A and 71B, pits and projections are formed across the line segment HL.

The pits and projections are formed by linear portions 72 (first linear portion) positioned on the X2 side of the line segment HL, linear portions 73 (second linear portion) positioned on the X1 side of the line segment HL, and linear portions 74 (third linear portion) connecting end portions of the linear portions 72 and 73.

The linear portions 72 and the linear portions 73 extend in parallel with the line segment HL. The linear portions 72 and 73 are alternately arranged in the Y direction. The linear portion 74 extends in a direction orthogonal to the line segment HL. When viewed from above, the rectangular pits and projections are continuously arranged in the Y direction at the boundary between the regions 71A and 71B.

The linear portions 72, 73, and 74 are formed by superimposing the ink ejected from the nozzle part 234 of the head 23 and the ink ejected from the nozzle part 244 of the head 24. That is, the linear portions 72, 73, and 74 are formed such that the end portion of the region 71A on the X1 side and the end portion of the region 71B on the X2 side are superimposed on each other.

In a state in which the dot positions of the heads 23 and 24 coincide with each other, a pit-projection shape extending across the line segment HL is difficult to visually recognize with the naked eye.

As illustrated in FIG. 20, the trapezoidal block 81 has a region 81A formed on the X2 side by the head 23 and a region 81B formed on the X1 side by the head 24 with the line segment HL as a boundary. The block 81 has an end portion 82 on the Y1 side and an end portion 83 on the Y2 side. The end portion 82 is a straight line extending parallel to the X direction. The end portion 83 is an oblique line inclined with respect to the X direction. The end portion 83 is inclined in a direction approaching the Y2 side from the X2 side toward the X1 side.

The line 91 is a linear line extending in the X direction. The line 91 has a region 91A formed on the X2 side by the head 23 and a region 91B formed on the X1 side by the head 24 with the line segment HL as a boundary.

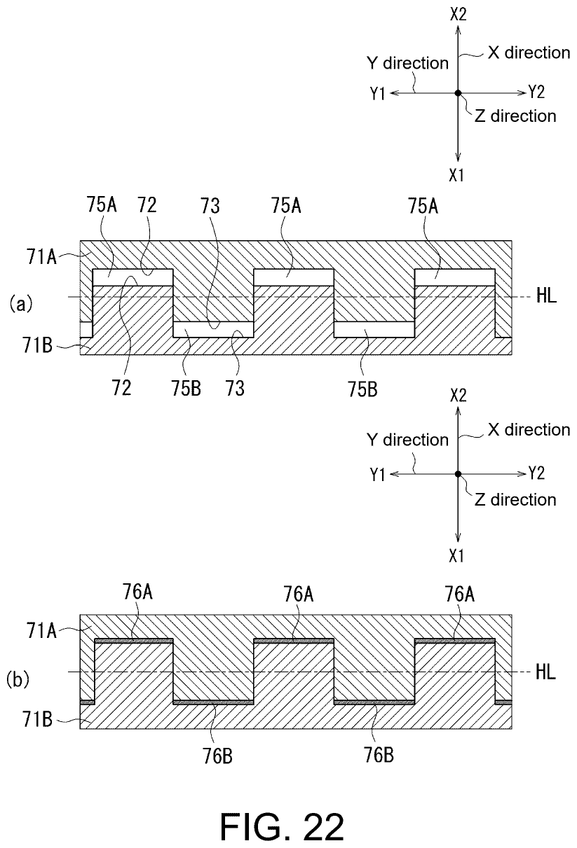

FIG. 22 is a view for illustrating a change in the test pattern 70 in the case of the positional misalignment of the heads 23 and 24 in the X direction. FIG. 22 illustrates a surrounding region of the line segment HL of the block 71. Here, (a) of FIG. 22 illustrates a case where the dot positions of the head 24 are misaligned to the X1 side of the dot positions of the head 23. In addition, (b) of FIG. 22 illustrates a case where the dot positions of the head 24 are misaligned to the X2 side of the dot positions of the head 23.

As illustrated in (a) of FIG. 22, in the case where the head 24 is misaligned to the X1 side in the X direction, the entire region 71B of the block 71 is displaced in a direction in which the region 71B is separated from the region 71A. Consequently, the end portion of the region 71A and the end portion of the region 71B are not superimposed, and a gap is generated at the boundary between the region 71A and the region 71B. Here, the gap means a portion where the ink is not ejected.

Specifically, a gap 75A is formed between the linear portion 72 of the region 71A and the linear portion 72 of the region 71B. A gap 75B is formed between the linear portion 73 of the region 71A and the linear portion 73 of the region 71B. The gaps 75A on the X2 side and the gaps 75B on the X1 side of the line segment HL are alternately arranged and continuously formed in the Y direction.

In a case where the gaps 75A and 75B are formed in the block 71, the user can discern that the dot positions of the head 24 are shifted to the X1 side with respect to the dot positions of the head 23. The user can correct the positional misalignment of the head 24 in the X direction by displacing the head 24 to the X2 side by a displacement mechanism (not illustrated).

As illustrated in (b) of FIG. 22, in a case where the head 24 is misaligned to the X2 side in the X direction, the entire region 71B of the block 71 is displaced in a direction in which the region 71B approaches the region 71A. Consequently, the end portion of the region 71B is displaced to the X2 side from the end portion of the region 71A and is superimposed on the region 71A.

Specifically, the linear portion 72 of the region 71B is superimposed on the region 71A, and a high-density region 76A is formed. The linear portion 73 of the region 71B is superimposed on the region 71A, and a high-density region 76B is formed. The high-density regions 76A and 76B are regions which has a color looking dark due to superimposition of the inks.

The high-density regions 76A on the X1 side and the high-density regions 76B on the X2 side of the line segment HL are alternately arranged in the Y direction and continuously formed.

In a case where the high-density regions 76A and 76B are formed in the block 71, the user can discern that the dot positions of the head 24 are misaligned to the X2 side with respect to the dot positions of the head 23. The user can adjust the positional misalignment of the head 24 by displacing the head 24 to the X1 side by a displacement mechanism (not illustrated).

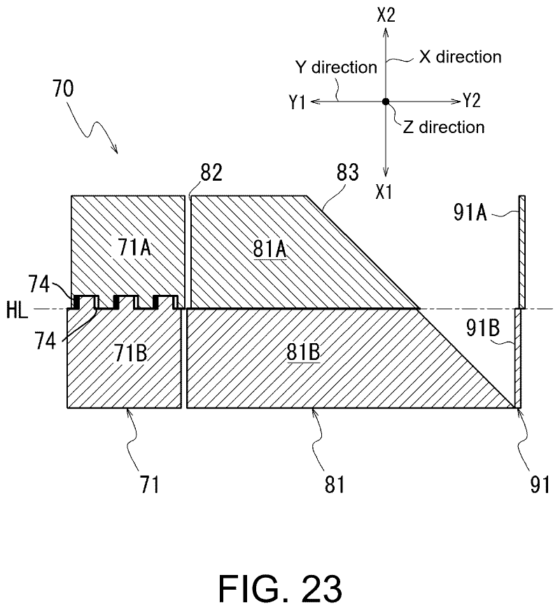

Although not illustrated, when the dot positions of the head 24 are misaligned in the X direction, a gap or a high-density region is also generated in the block 81 and the line 91 illustrated in FIG. 23. The user can also discern the positional misalignment of the heads 23 and 24 in the X direction from the block 81 and the line 91.

Here, in a case where the positional misalignment of the heads 23 and 24 in the X direction is slight, the gaps 75A and 75B or the high-density regions 76A and 76B decrease, and it may be difficult to visually recognize the gaps or the high-density regions in a single body. In particular, since the nozzle portions 234 and 244 eject the same color ink, it is difficult to visually recognize the high-density region. In the block 71, the gaps 75A and 75B or the high-density regions 76A and 76B are formed to be shifted in position to the X1 side and the X2 side of the line segment HL, and are observed alternately and continuously in the Y direction. Therefore, it is easy to visually recognize the gaps 75A and 75B or the high-density regions 76A and 76B are as a continuous pattern.

Here, a mode of discerning the positional misalignment of the head 24 in the X direction from the test pattern 70 has been described, and it is also possible to discern the positional misalignment in the Y direction and the tilts of the heads 23 and 24 from the test pattern 70.

FIG. 23 is a view illustrating the test pattern 70 in the case of the positional misalignment of the heads 23 and 24 in the Y direction.

FIG. 23 is a view illustrating the test pattern 70 in the case where the dot positions of the nozzle part 244 of the head 24 are misaligned to the Y1 side.

In the block 71, the region 71B is shifted to the Y1 side, so that the positions of the linear portion 74 of the region 71A and the linear portion 74 of the region 71B in the Y direction are misaligned. Consequently, a high-density region is formed in the linear portion 74 on the Y1 side, and a gap is generated in the linear portion 74 on the Y2 side.

In the block 81, the region 81B is misaligned to the Y1 side, so that steps are generated at positions where the line segment HL passes the end portions 82 and 83 in the Y direction. In particular, since the end portion 83 is an oblique side, it is easy to visually recognize the step.

Also in the line 91, the region 91B is misaligned to the Y1 side, so that a step is generated at a position where the line segment HL passes. The user can discern the misalignment of the dot positions in the test pattern 70 from these phenomena.

Although not illustrated, in a case where any one of the heads 23 and 24 is at a tilt, the region 91A or 91B of the line 91 is similarly inclined, and the line 91 is not a straight line continuous in the X direction. The user can discern the tilts of the heads 23 and 24 from this phenomenon.

In a case where these phenomena are confirmed in the test pattern 70, there is a possibility that the tilt correction or the dot position correction may not be sufficient, and thus it is possible to return to the adjustment using the test patterns 50 and 60.

In the above example, the example in which the linear portion 72 (first linear portion), the linear portion 73 (second linear portion), and the linear portion 74 (third linear portion) are formed as the end portions of the region 71A and the region 71B of the block 71 has been described, and the positional misalignment of the heads 23 and 24 can be discerned only by the linear portions 72 to 74. In the test pattern 70, only a pit-projection shape including the linear portions 72 to 74 may be printed by the heads 23 and 24 without printing the entire block 71.

In a case where the positional misalignment correction in the X direction from the test pattern 70 is completed, correction processing may be ended as illustrated in FIG. 8.

Alternatively, the test pattern 60 may be formed using a combination of nozzle portions other than the nozzle portions 234 and 244 of the heads 23 and 24. Even when the positional misalignment of the nozzle portions 234 and 244 in the Y direction is corrected, with the nozzle portions as a reference, a fine positional misalignment in the Y direction may occur in a combination of other nozzle portions. The test pattern 60 is formed even with a combination of other nozzle portions, and thereby highly accurate position correction can be performed.

Further, in a case where the tilt correction using the test pattern 50 is completed, and then the positional misalignment correction in the Y direction or the positional misalignment correction in the X direction is performed using the test patterns 60 and 70, the tilt correction using the test pattern 50 may be performed again. In all the test patterns, the correction processing may be ended in a stage in which there is no need to perform correction,

As described above, by performing adjustment using the test patterns 50, 60, and 70, the printing device 1 can perform printing in the state in which the dot positions of the heads 23 and 24 coincide with each other, and can enhance the print quality. A state in which the “dot positions (ink landing positions) of the heads 23 and 24 coincide with each other” includes not only a completely coinciding state but also a state in which there is misalignment to the extent that there is no problem in print quality.

In the embodiment, an example in which the test patterns 50, 60, and 70 are individually printed on the medium M has been described, and the present invention is not limited to this mode. The test patterns 50, 60, and 70 may be printed on the same medium M.

As described above, the test pattern 50 described in the embodiment has, for example, the following configuration.

(1) The test pattern 50 is printed on the medium M by ejecting the inks onto the medium M from the heads 23 and 24 (inkjet heads) including the plurality of nozzle portions 231 to 238 and 241 to 248.

Regions 51A and 52A of a test pattern 50 include the base lines 530 (first base lines) formed in the Y direction (first direction, main scanning direction) with the inks ejected from the nozzle portions 231 and 241 (first nozzle portions) of the heads 23 and 24, and the blocks 540 (first block) and the blocks 550 (second blocks) formed with the inks ejected from the nozzle portions 235 and 245 (second nozzle portions) provided at intervals from first nozzle portions 231 and 241 of the heads 23 and 24 in the Y direction.

The block 540 is formed on the X1 side (one side) in the X direction (second direction, sub scanning direction) orthogonal to the Y direction of the base line 530, and the blocks 550 are formed on the X2 side (the other direction).

In the case where the heads 23 and 24 are at tilts, the base line 530 is displaced relative to the blocks 540 and 550, so that there is a difference between the distance between the base line 530 and the block 540 and the distance between the base line 530 and the block 550. The user can discern the tilts of the heads 23 and 24 by checking the difference in distance.

(2) In the test pattern 50, the plurality of base lines 530 are formed at intervals in the X direction.

The plurality of blocks 540 are arranged in the X direction on the X1 side of each of the plurality of base lines 530.

The plurality of blocks 550 are arranged in the X direction on the X2 side of each of the plurality of base lines 530.

The set of the plurality of blocks 540 and the set of the plurality of blocks 550 are arranged at positions shifted from each other to overlap each other in the X direction.

The set of blocks 540 forms the arrow 54 (first figure). The set of blocks 550 forms the arrow 55 (second figure).

(3) The heads 23 and 24 are provided to be pivotable about the tilt shaft TA extending in the Z direction (third direction) orthogonal to the X direction and the Y direction.

(4) The arrow 54 as the first figure and the arrow 55 as the second figure are figures having different designs. One of the arrows 54 and 55 is visually recognized as a figure darker than the other depending on the pivoting direction of the tilt shaft TA of the heads 23 and 24.

In human vision, even with the same line type, there is an illusion that the density appears low when the distance between the lines is short, and the density appears high when the distance between the lines is long. The arrows 54 and 55 formed by the set of blocks 540 and the set of blocks 550 are visually recognized to have different densities depending on the tilt direction of the heads 23 and 24 (the pivoting direction of the tilt shaft). As a result, the user can discern the tilts of the heads 23 and 24 from the test pattern 50 with the naked eye. Since there is no need to use a tool such as a loupe, convenience can be improved.

The first figure and the second figure may have different designs, and are not limited to the arrows 54 and 55. The first figure and the second figure may be figures other than the arrows, and may be, for example, characters.

(5) the arrow 54 (first figure) and the arrow 55 (second figure) are each a mark indicating the pivoting direction of the tilt shaft TA.

For example, in the case where the printing device 1 includes the knob 225 that is interlocked with the pivoting mechanism of the tilt shaft TA, the first figure and the second figure can be the arrow 54 and the arrow 55 that indicate the pivoting directions of the knob 225. As a result, the user can easily discern, from the test pattern 50, the direction in which the knob is to be pivoted to adjust the tilts of the heads 23 and 24. That is, the user can adjust the tilts of the heads 23 and 24 by pivoting the knob 225 in the direction represented by an arrow having a dark color in the test pattern 50.

In the above embodiment, the counterclockwise arrow 54 and the clockwise arrow 55 indicating the pivoting directions of the knob 225 are illustrated as the mark indicating the pivoting directions of the tilt shaft TA, but the present invention is not limited to this mode. For example, the mark indicating the pivoting direction of the tilt shaft TA may be characters such as “counterclockwise” and “clockwise”. Alternatively, the characters “CCW” and “CW”, which are characters meaning “counterclockwise” and “clockwise”, may be displayed to indicate the pivoting direction of the tilt shaft TA.

In addition, in the above embodiment, the example in which the tilts of the heads 23 and 24 are adjusted by turning the knob 225 interlocked with the tilt mechanism has been described, but the present invention is not limited to this mode. For example, the user may pivot the tilt shaft TA to adjust the tilt by directly moving the heads 23 and 24 forward or backward without using the knob 225. In this case, the mark indicating the pivoting direction of the tilt shaft TA may be a linear arrow indicating the forward or backward movement direction of the heads 23 and 24.

(6) The nozzle part 231 (first nozzle part) and the nozzle part 235 (second nozzle part) of the printing device 1 each include the plurality of nozzles N arranged at regular intervals in the X direction.

The nozzles N1a, N1b, N1c, N1d, N1e . . . of the nozzle part 231 and the nozzles N5a, N5b, N5c, N5d, N5e, N5f. of the nozzle part 235 are alternately arranged in the X direction.

The base lines 530 are formed by the nozzles N1a, N1c, and N1e (first nozzles) of the nozzle part 231.

The blocks 540 are formed by the nozzles N5a, N5c, and N5e (second nozzles) of the nozzle part 235 which are adjacent to the nozzles N1a, N1c, and N1e on the X2 side in the X direction.

The blocks 550 are formed by the nozzles N5b, N5d, and N5f (third nozzles) of the nozzle part 235 which are adjacent to the nozzles N1a, N1c, and N1e on the X1 side in the X direction.

In the embodiment, by using the nozzle portions 231 and 235 having nozzles having different phases in the X direction, the combinations P1, P2, and P3 of the base lines 530 and the blocks 540 and 550 are formed with a width of three dots in the X direction. Consequently, the density of lines increases in the test pattern 50, and a difference in density between the arrows 54 and 55 occurs even with slight tilts of the heads 23 and 24, so that the highly accurate tilt correction can be performed.

(7) The Regions 51B and 52B of the test pattern 50 include the base lines 530 (second base lines), the blocks 540 (third blocks), and the blocks 550 (fourth blocks).

The base lines 530 (second base lines) are formed in the Y direction with the ink ejected from the nozzle portions 234 and 244 (third nozzle portions) of the heads 23 and 24.

The blocks 540 (third blocks) are formed with the inks ejected from the nozzle portions 238 and 248 (fourth nozzle portions) provided at intervals from the nozzle portions 234 and 244 of the heads 23 and 24 in the Y direction. The block 540 is formed adjacent to the base line 530 on the X1 side (one side) in the X direction of the base line 530.

The block 550 (fourth block) is formed with the inks ejected from the nozzle portions 238 and 248. The block 550 is formed adjacent to the base line 530 on the X2 side (the other side) in the X direction of the base line 530. The blocks 550 are arranged at intervals in the Y direction from the blocks 540.

The distance D3 in the Y direction between the nozzle portions 234 and 244 and the nozzle portions 238 and 248 forming the regions 51B and 52B is longer than the distance D2 in the Y direction between the nozzle portions 231 and 241 forming the regions 51A and 52A and the nozzle portions 235 and 245.

The regions 51A and 52A for coarse adjustment are formed by the nozzle portions in which the distance between the nozzle portions is short, and the regions 52A and 52B for fine adjustment are provided by the nozzle portions in which the distance between the nozzle portions is long. As a result, in the initial stage in which the heads 23 and 24 are at large tilts, the difference in density between the arrows 54 and 55 is likely to be observed in the regions 51A and 52A for coarse adjustment. In the stage in which the tilts of the heads 23 and 24 decrease as the tilt correction progresses, the difference in density between the arrows 54 and 55 is easily observed in the regions 51B and 52B for fine adjustment.

Since the test pattern 50 includes the regions 51A and 52A for coarse adjustment and the regions 51B and 52B for fine adjustment, the user can compare the regions 51A and 52A with the regions 51B and 52B in the test pattern 50, and thus transition from the coarse adjustment to the fine adjustment can be smoothly performed.

The regions 51A and 52A for coarse adjustment and the regions 51B and 52B for fine adjustment may be printed on different media M. Alternatively, the tilts of the heads 23 and 24 may be corrected only in the regions 51A and 52A for coarse adjustment or the regions 51B and 52B for fine adjustment.

Similar effects can be obtained in the printing method and the printing device 1 that prints the test pattern 50 described above.

### MODIFICATION EXAMPLE 1

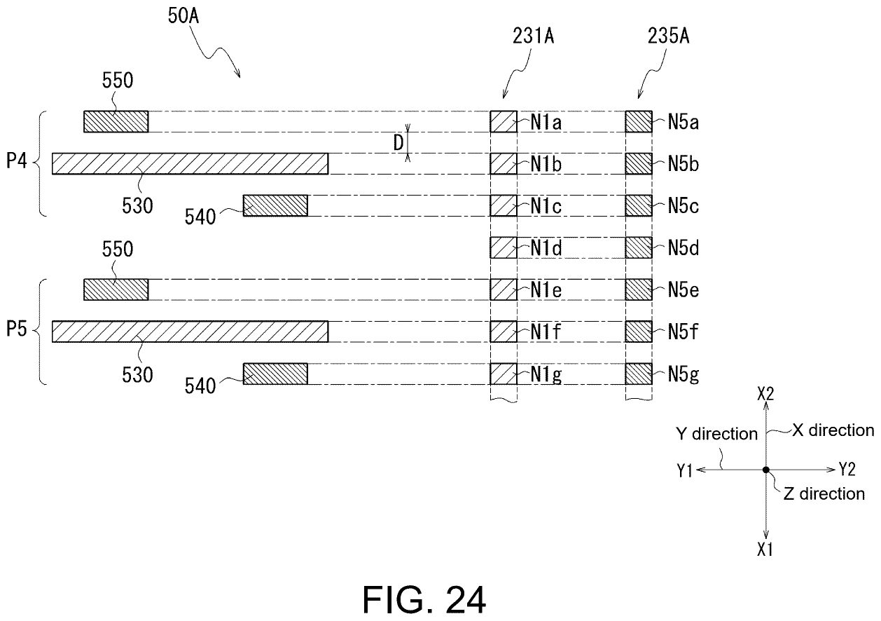

FIG. 24 is a view illustrating a method of forming a test pattern 50A according to Modification Example 1.

In the embodiment, the example in which the test pattern 50 is formed by the nozzle portions in which the nozzles are arranged to have a phase shift in the X direction has been described. In Modification Example 1, an example in which the test pattern 50A is formed by the nozzle portions in which nozzles are arranged at the same phase in the X direction will be described.

FIG. 24 illustrates an example in which nozzles of nozzle portions 231A and 235A are arranged at the same phase. The other nozzle portions can be similarly formed as long as the nozzle portions are a combination of nozzle portions having the same phase.

As illustrated in FIG. 24, nozzles N1a, N1b, N1c, N1d, N1e, N1f, N1g, . . . of the nozzle part 231A are arranged at intervals D from the X2 side toward the X1 side in the X direction.

Nozzles N5a, N5b, N5c, N5d, N5e, N5f, N5g, . . . of the nozzle part 235A are arranged at intervals D from the X2 side toward the X1 side in the X direction.

The nozzles of the nozzle part 231A are arranged at the same positions as the nozzles of the nozzle part 235A, respectively, in the X direction. That is, the nozzles of the nozzle part 231A and the nozzles of the nozzle part 235A are arranged in the same phase in the X direction.

FIG. 24 illustrates two combinations P4 and P5 of the base lines 530 and the blocks 540 and 550. The base line 530 is formed by the nozzle part 231A far apart from the tilt shaft TA, and the blocks 540 and 550 are formed by the nozzles of the nozzle part 235A close to the tilt shaft TA.

In the combination P4, the base line 530 is formed by the nozzle N1b of the nozzle part 231A. The block 540 is formed by the nozzle N5c on the X1 side of the nozzle N1b. The block 550 is formed by the nozzle N5a on the X2 side of the nozzle N1b.

The nozzle N5b having the same phase as the nozzle N1b is not used. The nozzles N1a and N1c having the same phase as the nozzles N5a and N5c are not used.

The blocks 540 and 550 are formed at an interval corresponding to one dot in the X direction with respect to the base line 530. The combination P4 is formed with a width corresponding to five dots in the X direction.

Between the combination P4 and the combination P5, an interval corresponding to three dots is provided in the X direction. Therefore, the nozzles N1d and N5d are not used.

In the combination P5, the base line 530 is formed by the nozzle N1f of the nozzle part 231A. The block 540 is formed by the nozzle N5g on the X1 side of the nozzle N1f. The block 550 is formed by the nozzle N5e on the X2 side of the nozzle N1f.

The nozzle N5f having the same phase as the nozzle N1f is not used. The nozzles N1e and N1g having the same phase as the nozzles N5e and N5g are not used. Similarly to the combination P4, the combination P5 is formed with a width corresponding to five dots in the X direction.

As described above, also in Modification Example 1, similarly to the embodiment, the block 540 is formed by the nozzle adjacent to the nozzle by which the base line 530 is formed, on one side (X1 side) in the X direction, and the block 550 is formed by the nozzle adjacent to the nozzle by which the base line 530 is formed, on the other side (X2 side).

However, in Modification Example 1, by using the nozzle part in which the nozzles are arranged to have the same phase, one combination of the base line 530 and the blocks 540 and 550 is formed with a wide width corresponding to five dots in the X direction. In addition, between the combinations P4 and P5, an interval corresponding to three dots is provided in the X direction. As described above, in the embodiment, one combination of the base line 530 and the blocks 540 and 550 is formed with a width corresponding to three dots in the X direction, and intervals corresponding to one dot in the X direction are provided between the combinations P1 to P3 (see FIG. 11).

That is, in the test pattern 50A of Modification Example 1, a distance between the base line 530 and the blocks 540 and 550 in the X direction is larger than that in the test pattern 50 of the embodiment. The test pattern 50A has a line density lower than that of the test pattern 50. That is, the test pattern 50A is less affected by the tilts of the heads 23 and 24 than the test pattern 50 is. Therefore, the test pattern 50A can be used for coarse adjustment in the case where the heads 23 and 24 are at large tilts, for example.

The printing device 1 may print the test pattern 50A of the modification example for coarse adjustment at a stage in which the heads 23 and 24 are at large tilts, and may print the test pattern 50 of the embodiment for fine adjustment at a stage in which the heads 23 and 24 are at small tilts.

As described above, the test pattern 50A described in Modification Example 1 has the following configuration.

(8) The nozzles N1a, N1b, N1c, N1d, N1e, N1f, N1g . . . of the nozzle part 231A (first nozzle part) of the printing device 1 and the nozzles N5a, N5b, N5c, N5d, N5e, N5f, N5g . . . of the nozzle part 235A (second nozzle part) are arranged at the same position in the X direction.

The base lines 530 are formed by the nozzles N1b and N1f (first nozzles) of the nozzle part 231A.

The blocks 540 (first blocks) are formed by the nozzles N5c and N5g (second nozzles) of the nozzle part 235A which are adjacent to the nozzles N1b and N1f on the X1 side (one side) in the X direction.

The blocks 550 (second blocks) are formed by the nozzles N5a and N5e (third nozzles) of the nozzle part 235B which are adjacent to the nozzles N1b and N1f on the X2 side (the other side) in the X direction.

The test pattern 50A can also be formed by a combination of nozzle portions in which nozzles are arranged in the same phase. In the test pattern 50A formed by the combination of the nozzle portions having the same phase, the density of the lines becomes lower, and thus, even in a case where the heads 23 and 24 are at large tilts, the difference in the density between the arrows 54 and 55 is easily observed, and thus, it is preferable to use the test pattern for coarse adjustment.

In addition, as described above, the test pattern 60 described in the embodiment has, for example, the following configuration.

(1) The test pattern 60 is printed on the medium M with inks ejected from the head 23 (first inkjet head) and the head 24 (second inkjet head).

The test pattern 60 includes the first lines 61 and the second lines 62 printed alternately in the Y direction (first direction).

The first line 61 is formed with the ink ejected from the plurality of nozzles N of the head 23 which are arranged in the X direction (second direction) orthogonal to the Y direction.

The second line 62 is formed with the ink ejected from the plurality of nozzles N of the head 24 which are arranged in the X direction.

In a case where the dot positions of the head 23 and the head 24 are misaligned in the Y direction, the positional relationship between the first line 61 and the second line 62 changes in the test pattern 60. The user can discern the misalignment of the dot positions of the heads 23 and 24 in the Y direction from the positional relationship between the first line 61 and the second line 62.

(2) The test pattern 60 has an overlap portion 630 in which the first line 61 and the second line 62 overlap each other when viewed in the Y direction.

In a case where the landing positions (dot positions) of the ink ejected from the nozzles N of the head 23 and the landing positions (dot positions) of the ink ejected from the nozzles N of the head 24 coincide in the X direction, the overlap portion 630 is visually recognized as a filled region.

In a case where the misalignment of the dot positions of the heads 23 and 24 are slight, it is difficult to confirm a change in the positional relationship between the first line 61 and the second line 62 with the naked eye. In a case where the dot positions of the heads 23 and 24 coincide with each other by arranging the second lines 62 to fill the intervals D4 between the first lines 61, the overlap portion 630 is visually recognized as a filled region. That is, when the dot positions of the heads 23 and 24 are misaligned in the Y direction, the uneven filling occurs in the overlap portion 630. The user can easily discern the positional misalignment with the naked eye.

(3) The test pattern 60 further includes the first reference line 64 and the second reference line 65.

The first reference line 64 is formed with the ink ejected from the nozzles N of the head 23.

The second reference line 65 is formed with the ink ejected from the nozzles N of the head 24.

In a case where the landing positions (dot positions) of the ink ejected from the nozzles N of the head 23 and the landing positions (dot positions) of the ink ejected from the nozzles N of the head 24 coincide in the Y direction, the first reference line 64 and the second reference line 65 have a superimposed region.

In the case where the dot positions of the head 23 and the head 24 are shifted in the Y direction, the second reference line 65 is not superimposed on the first reference line 64, and is shifted to the Y1 side or the Y2 side of the first reference line 64 according to the misalignment direction of the head 24.

By providing the first reference line 64 and the second reference line 65 separately from the overlap portion 630 where lines are densely arranged, it is possible to easily discern the misalignment direction of the head 24.

(4) In the block 71 of the test pattern 70 (pattern), the linear portion 72 (first linear portion) positioned on the X2 side (one side) of the line segment HL (virtual line) in the Y direction and the linear portion 73 (second linear portion) positioned on the X1 side (the other side) are alternately arranged in the Y direction.

The linear portion 72 and the linear portion 73 are formed by superimposing the ink ejected from the nozzles N of the head 23 and the ink ejected from the nozzles N of the head 24.

In a case where the dot positions of the heads 23 and 24 are misaligned in the X direction, the linear portion 72 and the linear portion 73 formed by both the heads 23 and 24 are not superimposed on each other, and printing is performed while the positions are shifted in the X direction. Even in the case where the positional misalignment in the X direction is slight, the positional misalignment is easily noticeable by alternately arranging the linear portions 72 and 73 in the Y direction. The user can easily discern the misalignment of the dot positions of the heads 23 and 24 in the X direction with the naked eye from the test pattern 70.

(5) The block 71 of the test pattern 70 has the region 71A (first region) and the region 71B (second region). The region 71A is positioned on the X2 side (one side) of the line segment HL, and is filled with the ink ejected from the nozzles N of the head 23. The region 71B is positioned on the X1 side (the other side) of the line segment HL, and is filled with the ink ejected from the nozzles N of the head 24.

The linear portion 72 and the linear portion 73 are formed by end portions facing the region 71A and the region 71B.

(6) In a case where the landing positions (dot positions) of the ink ejected from the nozzles N of the head 23 and the landing positions (dot positions) of the ink ejected from the nozzles N of the head 24 do not coincide in the X direction, the gaps 75A and 75B or the high-density regions 76A and 76B are generated at the boundary between the region 71A and the region 71B.

Since the gaps 75A and 75B or the high-density regions 76A and 76B generated at the boundary between the filled regions 71A and 71B are easily noticeable, the user can easily discern the positional misalignment from the test pattern 70. Further, since the gaps 75A and 75B or the high-density regions 76A and 76B are observed alternately and continually in the Y direction along the linear portion 72 and the linear portion 73, it is easier for the user to visually recognize the gaps and the high-density regions.

(7) In the test pattern 70, the linear portion 72 and the linear portion 73 are parallel to the line segment HL. The end portions of the linear portion 72 and the linear portion 73 are connected to each other by the linear portion 74 (third linear portion) orthogonal to the line segment HL.

The linear portion 74 is formed by superimposing the ink ejected from the nozzles N of the head 23 and the ink ejected from the nozzles N of the head 24.

The linear portion 72, the linear portion 73, and the linear portion 74 form a pit-projection shape at the boundary between the first region and the second region. Since the pit-projection shape is easily noticeable, the user can easily discern the positional misalignment of the heads 23 and 24. Further, in a case where the heads 23 and 24 are misaligned in the Y direction, the gaps 75A and 75B or the high-density regions 76A and 76B are generated along the linear portion 74, so that the user can also discern the positional misalignment of the heads 23 and 24 in the Y direction from the test pattern 70.

Similar effects can be obtained in the printing method and the printing device that prints the test patterns 60 and 70 described above.

The present invention is not limited to the embodiments described above, and can be appropriately modified within the scope of the technical ideas of the present invention.

### (Supplement)

A test pattern that is printed on a medium with inks ejected from a first inkjet head and a second inkjet head, the test pattern including: first linear portions positioned on one side in a second direction (direction orthogonal to a first direction) from a virtual line, with the virtual line as a reference in the first direction, and second linear portions positioned on the other side, in which the first linear portion and the second linear portion are alternately printed side by side in the first direction, and the first linear portions and the second linear portions are formed by superimposing the ink ejected from nozzles of the first inkjet head and the ink ejected from nozzles of the second inkjet head.

(B) A test pattern printing method for printing a test pattern on a medium by ejecting inks from a first inkjet head and a second inkjet head, the test pattern printing method including: printing first linear portions positioned on one side in a second direction (direction orthogonal to a first direction) from a virtual line, with the virtual line as a reference line in the first direction, and second linear portions positioned on the other side, alternately in the first direction, and the first linear portions and the second linear portions are formed by superimposing the ink ejected from nozzles of the first inkjet head and the ink ejected from nozzles of the second inkjet head.

(C) A printing device that prints a test pattern on a medium by ejecting inks from a first inkjet head and a second inkjet head, the printing device performing: printing first linear portions positioned on one side in a second direction (direction orthogonal to a first direction) from a virtual line, with the virtual line as a reference line in the first direction, and second linear portions positioned on the other side, alternately in the first direction, and the first linear portions and the second linear portions are formed by superimposing the ink ejected from nozzles of the first inkjet head and the ink ejected from nozzles of the second inkjet head.

### REFERENCE SIGNS LIST

1 Printing device
2 Main body
3 Trestle
21 Platen
22 Head portion
23 Inkjet head (first inkjet head)
231 Nozzle part (first nozzle part)
234 Nozzle part (third nozzle part)
235 Nozzle part (second nozzle part)
238 Nozzle part (fourth nozzle part)
24 Inkjet head (second inkjet head)
241 Nozzle part (first nozzle part)
244 Nozzle part (third nozzle part)
245 Nozzle part (second nozzle part)
248 Nozzle part (fourth nozzle part)
225 Tilt adjusting knob
226 Displacement adjusting knob
25 Ultraviolet irradiation portion
26 Operation panel
27 Controller
28 Ink supply mechanism
281 Ink bottle
282 Ink supply channel
29 Moving mechanism
291 Carriage
292 Guide rail
30 Feeding mechanism
50 Test pattern
51A, 51B, 52A, 52B Region
53 Base
530 Base line
54 Arrow (first figure)
540 Block (first block)
55 Arrow (second figure)
550 Block (second block)
60 Test pattern
610 First line portion
61 First line
620 Second line portion
62 Second line
630 Overlap portion
64 First reference line
65 Second reference line
660 Sample block
70 Test pattern
71 Block
71A Region (first region)
71B Region (second region)
72 Linear portion (first linear portion)
73 Linear portion (second linear portion)
74 Linear portion (third linear portion)
75A, 75B Gap
76A, 76B High-density region
81 Block
81A, 81B Region
82, 83 End portion
91 Line
91A, 91B Region
TA Tilt shaft
HL Line segment (virtual line)
M Medium
Y Main scanning direction (first direction)
X Sub scanning direction (second direction)

1. A test pattern that is printed on a medium by ejecting inks onto the medium from an inkjet head including a plurality of nozzle portions, the test pattern comprising:
first base lines formed in a first direction with inks ejected from first nozzle portions of the inkjet head; and
first blocks and second blocks formed with inks ejected from second nozzle portions of the inkjet head which are provided at intervals from the first nozzle portions in the first direction,
wherein
the first blocks are formed on one side of each of the first base lines in a second direction orthogonal to the first direction, and the second blocks are formed on the other side of each of the first base lines.

2. The test pattern as set forth in claim 1, wherein
a plurality of the first base lines is formed at intervals in the second direction,
a plurality of the first blocks is arranged in the second direction on the one side of each of the plurality of first base lines,
a plurality of the second blocks is arranged in the second direction on the other side of each of the plurality of first base lines,
the plurality of first blocks and the plurality of second blocks are arranged at positions shifted from each other such that the first and second blocks do not overlap each other in the second direction, and
a set of the first blocks forms a first figure, and a set of the second blocks forms a second figure.

3. The test pattern as set forth in claim 2, wherein
the inkjet head is provided to be pivotable about a tilt shaft extending in a third direction orthogonal to the first direction and the second direction.

4. The test pattern as set forth in claim 3, wherein
the first figure and the second figure are figures having different designs, and one of the first figure and the second figure is visually recognized as a figure darker than the other depending on a pivoting direction of the tilt shaft.

5. The test pattern as set forth in claim 3 4, wherein
each of the first figure and the second figure includes a mark indicating the pivoting direction of the tilt shaft.

6. The test pattern as set forth in claim 1, wherein
the first nozzle portions and the second nozzle portions each include a plurality of nozzles arranged at regular intervals in the second direction,
the nozzles of the first nozzle portions and the nozzles of the second nozzle portions are alternately arranged in the second direction,
the first base lines are formed by first nozzles of the first nozzle portions,
the first blocks are formed by second nozzles of the second nozzle portions, the second nozzles being adjacent to the first nozzles on one side in the second direction, and
the second blocks are formed by third nozzles of the second nozzle portions, the third nozzles being adjacent to the first nozzles on the other side in the second direction.

7. The test pattern as set forth in claim 1, wherein
the first nozzle portions and the second nozzle portions include a plurality of nozzles arranged at regular intervals in the second direction,
the nozzles of the first nozzle portions and the second nozzle portions are arranged at the same positions in the second direction,
the first base lines are formed by first nozzles of the first nozzle portions,
the first blocks are formed by second nozzles of the second nozzle portions, the second nozzles being adjacent to the first nozzles on one side in the second direction, and
the second blocks are formed by third nozzles of the second nozzle portions, the third nozzles being adjacent to the first nozzles on the other side in the second direction.

8. The test pattern as set forth in claim 1, further comprising:
second base lines formed in the first direction with inks ejected from third nozzle portions of the inkjet head; and
third blocks that are formed with inks ejected from fourth nozzle portions of the inkjet head at intervals from the third nozzle portions in the first direction and are adjacent to the second base lines on one side of the second base lines in the second direction; and
fourth blocks formed with inks ejected from the fourth nozzle portions to be adjacent to the second base lines on the other side of the second base lines in the second direction and be arranged separately from the third blocks at an interval in the first direction,
wherein
a distance between the third nozzle portions and the fourth nozzle portions in the first direction is longer than a distance between the first nozzle portions and the second nozzle portions in the first direction.

9. (canceled)

10. A printing device that prints a test pattern on a medium by ejecting inks onto the medium from an inkjet head including a plurality of nozzle portions, the printing device is configured to form:
first base lines in a first direction by ejecting inks onto the medium from first nozzle portions of the inkjet head; and
first blocks and second blocks by ejecting inks from second nozzle portions of the inkjet head which are provided at intervals from the first nozzle portions in the first direction,
wherein
the first blocks are formed on one side of each of the first base lines in a second direction orthogonal to the first direction, and the second blocks are formed on the other side of each of the first base lines.

11. A test pattern that is printed on a medium with inks ejected from a first inkjet head and a second inkjet head, the test pattern comprising:
first lines and second lines printed alternately in a first direction,
wherein
the first lines are formed with inks ejected from a plurality of nozzles of the first inkjet head which are arranged in a second direction orthogonal to the first direction, and
the second lines are formed with inks ejected from a plurality of nozzles of the second inkjet head which are arranged in the second direction.

12. The test pattern as set forth in claim 11, wherein
the first line and the second line have an overlap portion where the lines overlap each other when viewed in the first direction, and
the overlap portion is visually recognized as a filled region in a case where landing positions of the inks ejected from the nozzles of the first inkjet head and landing positions of the inks ejected from the nozzles of the second inkjet head coincide in the first direction.

13. The test pattern as set forth in claim 11, further comprising:
a first reference line formed with the inks ejected from the nozzles of the first inkjet head; and
a second reference line formed with the inks ejected from the nozzles of the second inkjet head,
wherein
in a case where the landing positions of the inks ejected from the nozzles of the first inkjet head and the landing positions of the inks ejected from the nozzles of the second inkjet head coincide in the first direction, the first reference line and the second reference line have a superimposed region.

14. The test pattern as set forth in claim 11, further comprising:
a pattern in which, with a virtual line in the first direction as a reference, first linear portions positioned on one side in the second direction from the virtual line and second linear portions positioned on the other side are alternately arranged in the first direction,
wherein
the first linear portions and the second linear portions are formed by superimposing the inks ejected from the nozzles of the first inkjet head and the inks ejected from the nozzles of the second inkjet head.

15. The test pattern as set forth in claim 14, wherein
the pattern has, on the one side of the virtual line, a first region filled with the inks ejected from the nozzles of the first inkjet head and, on the other side, a second region filled with the inks ejected from the nozzles of the second inkjet head, and
the first linear portions and the second linear portions are formed by facing end portions of the first region and the second region.

16. The test pattern as set forth in claim 15, wherein
in a case where the landing positions of the inks ejected from the nozzles of the first inkjet head and the landing positions of the inks ejected from the nozzles of the second inkjet head do not coincide in the second direction, a gap or a high-density region is generated at a boundary between the first region and the second region.

17. The test pattern as set forth in claim 14, wherein
the first linear portions and the second linear portions are parallel to the virtual line,
end portions of the first linear portions and the second linear portions are connected to each other by third linear portions orthogonal to the virtual line, and
the third linear portions are formed by superimposing the inks ejected from the nozzles of the first inkjet head and the inks ejected from the nozzles of the second inkjet head.

18. (canceled)

19. (canceled)
